(19) United States
(12) Patent Application Publication
(10) Pub. No.: US 2025/0344009 A1
(43) Pub. Date: Nov. 6, 2025

(54) REDUCED COMPUTING AND/OR POWER RESOURCES, REACTIVE MASKING OF ENVIRONMENTAL SOUND, AND/OR FINE-TUNABLE ISO STATE MANAGEMENT THROUGH GENERATIVE AUDIO SUCH AS SYNTHESIZED AUDIO RENDERED ON A DIGITAL SIGNAL PROCESSOR OF AN EARPHONE

(71) Applicant: Stealth Labs Inc., Brookline, MA (US)

(72) Inventors: YADID AYZENBERG, Brookline, MA (US); AMIR LAZAROVICH, Apex, NC (US); STUART E. ROSS, Brookline, MA (US)

(21) Appl. No.: 18/653,302

(22) Filed: May 2, 2024

(51) Int. Cl. H04R 1/10; G06F 3/01; G06F 3/16; G10K 11/175; G10K 15/02

(52) U.S. Cl. CPC H04R 1/1041; G06F 3/015; G06F 3/165; G10K 11/1752; G10K 15/02; H04R 1/1016; H04R 1/1083; H04R 2420/07; H04R 2430/01; H04R 2430/03; H04R 2460/03

(57) ABSTRACT

Disclosed is a method, a device, and/or a system of reduced computing and/or power resources, reactive masking of environmental sound, and/or fine-tunable ISO state management through generative audio such as synthesized audio rendered on a digital signal processor of an earphone. In one embodiment, a method includes initiating sound on a speaker of an earbud from an audio track. One or more physiological features of the user may be determined from physiological data received on sensors of the earbud. A cognitive state of the user may be determined to include a sleep state based on the physiological features, and a generative audio is initiated in response. The generative audio may be faded into the audio and the audio track faded out of the audio such that the generative audio replaces the audio track to reduce power consumption of the earbud associated with playing the audio track.

### FIELD OF TECHNOLOGY

This disclosure relates generally to earphones and audio processing and, more particularly, to a method, a device, and/or a system of reduced computing and/or power resources, reactive masking of environmental sound, and/or fine-tunable ISO state management through generative audio such as synthesized audio rendered on a digital signal processor of an earphone.

### BACKGROUND

Earphones that provide sound directly to an ear canal of a user, including earbuds that are held in place by the shape of the ear, have become prevalent personal devices. The attractiveness, comfort, energy lifespan, and other features of earphones are increasingly valued in both business and consumer markets.

One valued aspect of earphones may include a small form-factor that can increase comfort. This may be especially useful for earbuds that are intended to be positioned within and/or held by the ear so that the earbuds easily and ergonomically fit. Certain specialized uses, for example earphones that aid in helping a user rest or sleep, may implicate comfort considerations, for example ensuring a user sleeping on their side (sometimes known as a “side sleeper”) does not experience increased pressure on sensitive parts of ear from the earphone and/or earbud. As the earphone must generally be self-powered with a battery, power consumption can result in the need for a larger battery. This can create tension between designing a compact and/or comfortable form factor. It is therefore advantageous to find new ways to efficiently utilize power for earphones, especially for earbuds.

Another aspect of value in earphones is the ability to block and/or “mask” sound. This can take the form of active masking, in which sound is played on a speaker of the earphone to mask other sounds within the sleep environment of the user. However, sound masking can sometimes result in incongruous sound production that can be distracting or inhibit the user achieving relaxation, rest, and/or sleep. In such case, the masking sound may be only marginally better (or sometimes worse) than the environmental noise intended to be masked. Masking may also require significant power usage, which can also conflict with form factor. Alternative strategies with masking utilizing an audio track may also use substantial power, especially if streamed to earbuds from a device such as a smart phone.

Yet another aspect of value in earphones is assistance with managing an emotional and/or cognitive state, for example an excited state to a calm state, and/or an awake state to a sleep state. One known system of measuring cognitive state is referred to as the “ISO state” (or iso state) state of the user, which may be based on the ISO principle. In one definition, the ISO principle includes a technique by which music or other sound is matched with the mood of a [user], then gradually altered to affect the desired mood state. This technique can also be used to affect physiological responses such as heart rate and blood pressure” (Davis, Gfeller, & Thaut, 2008). Factors known to affect ISO state may include the number of tones, which tones are played together, how particular tonal arrangements are made, tempos, music styles and/or other factors. One challenge of using the ISO principle includes effectively managing ISO state in a way that is both interesting and non-distracting to a user, especially one that may be trying to enter a rest state and/or a sleep state. For example, audio tracks that are prerecorded have set tones, instrumental arrangements, and other fixed attributes, and attempting to influence the ISO state may require changing to a different audio track with different audio properties. This switch is generally both noticeable, distracting, and potentially awakening for the user. Further, when using fixed pre-recorded audio loops, transitions may become noticeable and distracting to the user, especially with short loops, as such artifacts may tend to repeat themselves. Significant power may also be required to maintain or support the audio track, e.g., over a wireless network connection.

New and improved methods are desired and economically valuable to improve battery performance, including as reduced power can result in a smaller battery which can enhance comfort and attractiveness of earbuds by decreasing their form factor. New and improved methods are desired and economically valuable for low power and/or effective sound masking, especially masking that is low distraction or supports sleep. Finally, new and improved methods are desired and economically valuable for managing emotional and/or cognitive state of a user, especially to assist the use in achieving rest and/or sleep.

### SUMMARY

Disclosed are a method, a device, and/or a system of reduced computing and/or power resources, reactive masking of environmental sound, and/or fine-tunable ISO state management through generative audio such as synthesized audio rendered on a digital signal processor of an earphone.

In one embodiment, a method includes initiating sound on a speaker of an earbud of an user, the sound produced from an audio having an audio track. The method also includes determining one or more physiological features of the user from physiological data received on one or more sensors of the earbud. The method further includes determining that a cognitive state of the user includes a sleep state based on the one or more physiological features. The method in addition includes initiating a generative audio in response to a determination of the sleep state of the user, and fading the generative audio into the audio such that the audio further may include the generative audio. The method may also include fading the audio track out of the audio such that the generative audio replaces the audio track to reduce power consumption of the earbud associated with playing the audio track. Other embodiments of this aspect include corresponding computer systems, apparatus, and computer programs recorded on one or more computer storage devices, each configured to perform the actions of the methods.

Implementations may include one or more of the following features. The method where the audio track is streamed to the earbud with a wireless connection, the method may include: terminating the wireless connection upon fading the audio track out of the audio, where the audio track is streamed from at least one of a mobile device communicatively coupled with the earbud, a base station of the earbud communicatively coupled with the earbud, and a computing device communicatively coupled to the earbud. The method where the generative audio may include a synthesized audio having one or more digital soundwave descriptors. The method may include: inputting the one or more digital soundwave descriptors into a digital signal processor of a microprocessor of the earbud, referred to as a DSP; generating an audio waveform on the DSP of the microprocessor; and transmitting the audio waveform to a digital-to-analog converter of the earbud, where the synthesized audio generated by an analog waveform of the audio waveform transformed by the digital-to-analog converter and transmitted to the speaker of the earbud. The method may include: parsing the audio track to determine a track feature of the audio track having an audio waveform of the track feature and an occurrence frequency the audio waveform of the track feature, where the audio waveform of the track feature having one or more waves each having a soundwave frequency and soundwave amplitude; and generating a generative feature having an audio waveform of the generative feature, the audio waveform of the generative feature having a set of one or more waves within a channel limit of the DSP, the audio waveform of the generative feature approximating the audio waveform of the track feature within the channel limit of the DSP; generating within the generative audio the generative feature, where the generative audio is generated at the occurrence frequency. The method may include: randomizing occurrence of the generative feature within the audio played on the speaker of the earbud, where the one or more physiological features having at least one of a heart rate of the user, a heart rate variability of the user, a respiration rate of the user, a respiration rate variability of the user, and a temperature of the user, where the physiological data describes one or more physiological indicators; generating a soundwave descriptor library having the digital soundwave descriptor and one or more additional instances of the digital soundwave descriptor; and transmitting the soundwave descriptor library to the earbud and storing the soundwave descriptor library in a computing memory of the earbud, where the generative audio extracted from the soundwave descriptor library stored on the computing memory of the earbud. The method where the generative audio may include a set of two or more sound samples that are composed such that the set of two or more sound samples are at least one of sequenced and overlayed. Implementations of the described techniques may include hardware, a the method or process, or a computer tangible medium.

In another embodiment, a method includes initiating sound on a speaker of an earbud of an user, the sound produced from an audioscape, having one or more audio features extracted from a generative library that has two or more generative features arrangeable in real time to produce the audioscape. The method also includes collecting a first instance of the environmental sound from an environment of the user and storing the environmental sound as an environmental audio data; where the first instance of the environmental sound collected on at least one of a microphone of the earbud and a microphone of a device communicatively coupled to the earbud. The method further includes isolating an environmental feature of the environmental sound from the environmental audio data, where the environmental feature of the environmental sound includes an audio waveform of the environmental sound having a plurality of waves. The method in addition include decomposing the audio waveform of the environmental sound into two or more waves that are an approximation of the audio waveform of the environmental sound, each wave of the two or more waves including of a soundwave frequency and a soundwave amplitude, where decomposition of the audio waveform having an application of a Fourier transform and identification of one or more dominant frequency bands. The method includes determining whether at least one of the two or more generative features of the generative library meets a masking threshold for the audio waveform of the environmental sound. The method also includes determining a second instance of the environmental sound has been collected by the microphone of the earbud. The method then generates a masking sound to mask the second instance of the environmental sound by playing a generative feature on the speaker of the earbud. Other embodiments of this aspect include corresponding computer systems, apparatus, and computer programs recorded on one or more computer storage devices, each configured to perform the actions of the methods.

Implementations may include one or more of the following features. The method may include: comparing one or more attributes of the audio waveform of the environmental sound with one or more attributes of an audio waveform of at least one of the two or more generative features within the generative library; determining that the two or more generative features of the generative library are insufficient to mask the environmental sound; and applying at least one of a frequency transformation and an amplitude transformation to the audio waveform of at least one of the two or more generative features to create a low-power masking sound within the audioscape of the generative library. The method where the generative library may include a soundwave descriptor library and the generative feature may include one or more digital soundwave descriptors. The method where the generative library may include an audio sample library and the generative feature may include an audio sample. The method may include: setting an ISO limit value in the computing memory establishing a feature rate limit for production of a sound associated with the generative feature within a time period; upon determining the second instance of the environmental sound has been collected by the microphone of the earbud querying the ISO limit value; and determining production of the sound associated with the generative feature is within the ISO limit value prior to playing the generative feature. The method may include: determining that the two or more generative features of the generative library are insufficient to mask the environmental sound; and generating a new instance of the generative feature; adding the new instance of the generative feature to the generative library as a masking feature; and removing the new instance of the generative feature from the generative library upon termination of a sleep session of the user. Implementations of the described techniques may include hardware, a the method or process, or a computer tangible medium.

In yet another embodiment, the method includes receiving at a first time one or more physiological features of the user from one or more sensors of the earbud configured to collect physiological indicators. The method includes determining that the ISO state of the user which may include a heightened iso state based on one or more physiological features determined based on the physiological indicators collected at the first time. The method further includes generating on a speaker of the earbud a sound from an audio, the audio having two or more generative features each having one or more digital soundwave descriptors extracted from a soundwave descriptor library stored on a computing memory of the earbud, where the two or more generative features rendered at a first rate matching the ISO state of the user at the first time, and where the two or more generative features rendered with a digital signal processor (DSP) of the earbud and a digital-to-analog converter (DAC) of the earbud. The method reduces the first rate to a second rate of generative features rendered that is slower than the first rate. The method receives at a second time one or more physiological features of the user from the one or more sensors of the earbud. The method may also include determining that the ISO state of the user includes a reduced ISO state based on the one or more physiological features received at the second time. The method further includes maintaining the second rate of generative feature production, to adaptively manage the ISO state of the user utilizing reduced power and memory of the earbud. Other embodiments of this aspect include corresponding computer systems, apparatus, and computer programs recorded on one or more computer storage devices, each configured to perform the actions of the methods.

Implementations may include one or more of the following features. The method may include: reducing a number of generative features permitted to be rendered within the soundwave descriptor library upon a determination of the reduced ISO state. The method may include: reducing volume of at least one of the two or more generative features rendered from the soundwave descriptor library upon the determination of the reduced ISO state, and lowering a tone of at least one of the two or more generative features rendered from the soundwave descriptor library upon the determination of the reduced ISO state. The method may include: fading the two or more generative features out of the audio; and fading a broad spectrum mask into the audio such that the broad spectrum mask replaces the two or more generative features, where the broad spectrum mask is at least one of a white noise, a pink noise, and a brown noise. The method may include: setting an ISO limit value in the computing memory establishing a feature rate limit for production of a generative sound within a time period; upon determining an environmental sound has been collected by a microphone of the earbud querying the ISO limit value; determining production of a masking sound is within the ISO limit value based on one or more rendered generative features; and generating the masking sound. The method may include: querying an ISO baseline value of the user established through one or more pre-sleep sessions of the user. The method where the determination of the ISO state of the user based on comparison to the ISO baseline value of the user, where the heightened iso state is an excited state of the user, and where the reduced iso state is a calm state of the user. Implementations of the described techniques may include hardware, the method or process, or a computer tangible medium. Systems, devices, and computer readable media utilizing and executing some or all of the aspects of the above methods are also shown and described herein.

### BRIEF DESCRIPTION OF THE DRAWINGS

The embodiments of this disclosure are illustrated by way of example and not limitation in the figures of the accompanying drawings, in which like references indicate similar elements and in which:

FIG. 1 illustrates a generative audio network including one or more earphones, such as earbuds, one or more devices, such as mobile devices and/or base stations, and one or more servers, individually and collectively enabling efficient power usage of the earphone and/or smaller battery size by transitioning generative audio upon a trigger event, efficient masking of the earphone including utilizing existing or new generative features blending with existing generative libraries, and/or efficient ISO management using generative audio, according to one or more embodiments.

FIG. 2 illustrates the earphone of FIG. 1, including a playback routine for playing traditional audio tracks, a digital signal processor (DSP) usable for creation of power efficient and/or rapidly adaptive generative audio, a generative audio engine, a generative masking engine, a mask feature generation engine, and an ISO management engine, according to one or more embodiments.

FIG. 3 illustrates the device of FIG. 1, for example the mobile device and/or the base station, which may include any portion or all of the software engines or other computer readable instructions of FIG. 2, and which further may include one or more generative libraries, track databases, and/or a user profiles to support the function of the earphone, according to one or more embodiments.

FIG. 4 illustrates the server, which may include one or more engines such as the mask feature generation engine, a master generative library storing one or more soundwave descriptor libraries, and/or a track catalogue soundwave descriptor libraries, and further illustrating a soundscape pair associating a high resolution version with a low resolution version, for example to enhance seamless transition to generative audio perceivable by the user, according to one or more embodiments.

FIG. 5 illustrates a generative audio system including playing generative audio comprised of one or more generative features, the generative audio comprising the composition of samples and/or the rendering of digital soundwave descriptors by the DSP to generate an audioscape, according to one or more embodiments.

FIG. 6 illustrates another generative audio system including supporting transitioning from predefined audio such as an audio track that is played and/or streamed by the playback routine to generative audio comprised on one or more generative features rendered on the DSP, for example for increased power efficiency, masking flexibility, and/or ISO state management, according to one or more embodiments.

FIG. 7 illustrates yet another generative audio system including generation of a masking feature to efficiently mask an environmental sound utilizing a generative feature existing within the generative library, a transformed generative feature of the generative library, and/or a new masking feature, according to one or more embodiments.

FIG. 8 illustrates a generative audio process flow, according to one or more embodiments.

FIG. 9 illustrates a generative audio transition process flow, according to one or more embodiments.

FIG. 10 illustrates an audio parsing process flow through which generative features emulating an audio track can be produced, according to one or more embodiments.

FIG. 11 illustrates a generative masking process flow, according to one or more embodiments.

FIG. 12 illustrates a mask transformation and/or generation process flow, according to one or more embodiments.

FIG. 13 illustrates a generative audio ISO management process flow, according to one or more embodiments.

FIG. 14 illustrates a broad mask transition process flow, according to one or more embodiments.

FIG. 15 illustrates an ISO-masking transition process flow, according to one or more embodiments.

FIG. 16 illustrates an example generative feature masking and transformation graph, according to one or more embodiments.

Other features of the present embodiments will be apparent from the accompanying drawings and from the detailed description that follows.

### DETAILED DESCRIPTION

Disclosed are a method, a device, and/or a system of reduced computing and/or power resources, reactive masking of environmental sound, and/or fine-tunable ISO state management through generative audio such as synthesized audio rendered on a digital signal processor of an earphone.

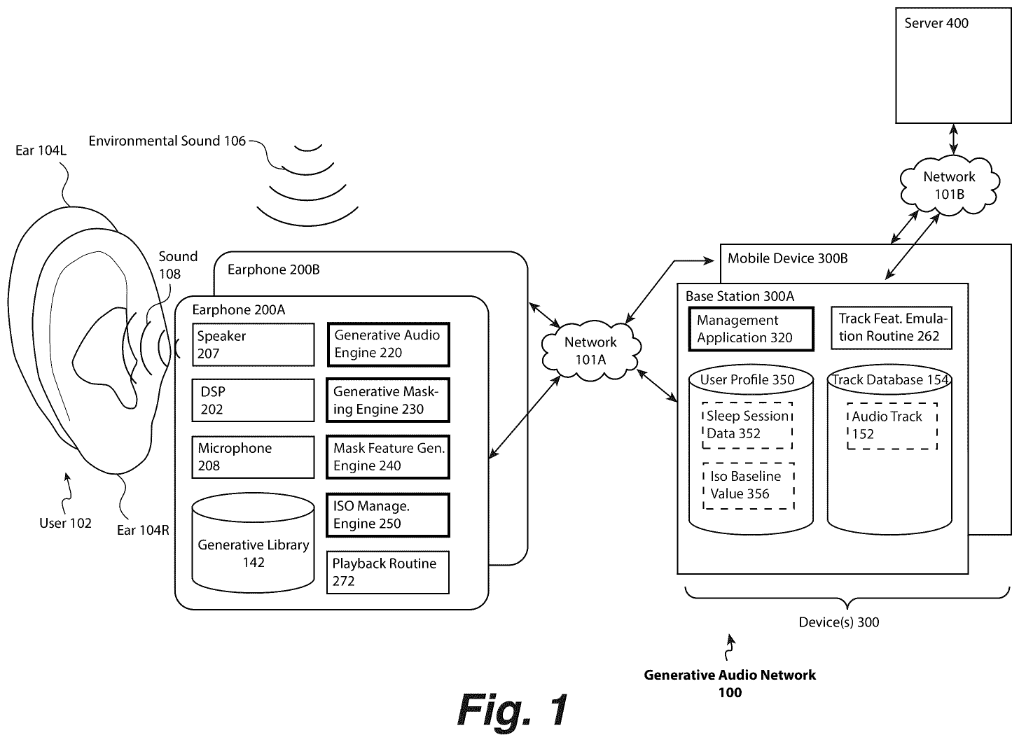

FIG. 1 illustrates a generative audio network 100, according to one or more embodiments. The generative audio network 100 may include one or more earphones 200 (such as earbuds), one or more devices 300 (e.g., a base station 300A such as a charging case for the earphones 200, and/or a mobile device 300B such as a smartphone), and/or one or more servers 400, each of which may be communicatively coupled with one or more networks 101.

A user 102 may receive sound 108 from the speaker 207 of the earphone 200. For example, a right ear 104R of the user 102 may receive the sound 108 from the speaker 207 of the earphone 200A, and a left ear 104L of the user 102 may receive the sound 108 from an earphone 200B. It will be recognized that whenever an element, component, and/or process of an earphone 200 is shown or described herein, such element, component, and/or process may occur the earphone 200L and/or the earphone 200R. Reference to an “earphone 200” herein means either a single instance of an earphone 200, one of the earphone 200L and the earphone 200R, and/or both of the earphone 200L and the earphone 200R, unless where noted or required by context.

The user 102 may be utilizing the headphones 200 such as the earbuds for one or more purposes, including, for example: listening to content, such as music or audiobooks; helping the user 102 to focus their mental state, including through masking of environmental sounds 106; helping to relax with music or other sound; assisting with a change in emotional state and/or ISO state, for example to reduce an excited state or a calm state, and; assisting with a change in cognitive state (e.g., an awake state to a sleep state).

In one or more embodiments, the sound 108 may be generated from the earphone 200 utilizing a straightforward playback of an audio track 152, for example with the playback routine 272. In one or more embodiments, the audio track 152 may either be stored on the memory of the earphone 200 (e.g., the memory 203), or may be streamed from the memory of the device 300 (e.g., the memory 303), temporarily buffered in the memory 203, and played during simultaneous streaming and/or buffering. As will be recognized by one skilled in the art, and especially for an earbud with a limited form factor, the memory 203 may be substantially limited compared with that of the device 300. As a result, in one or more embodiments, where multiple audio tracks 152 and/or large audio tracks 152 are desired to be stored by the user 102 for access, such audio track 152 may be stored on the device 300 (and/or in the server 400). In such case, the device 300 may respond to a playback request from the user 102 which may stream the audio track 152 or portion thereof to the earphone 200 through the network 101A. In one or more embodiments, a wireless network is utilized for the network 101A because it may increase the flexibility and range of motion of the user 102, especially if the user 102 is trying to exercise, or, conversely, achieve relaxation and/or a sleep state. For example, the network 101 that is a wireless network may be a Bluetooth® network, a WiFi® network, and/or other wireless protocol. However, as also will be recognized by one skilled in the art, maintaining the network connection 101A that is wireless (e.g., a radio frequency connection) may require significant power utilization, especially for the earphone 200 which may have a limited battery (e.g., the battery 206). To have a useful and/or advantageous “lifespan” on a single charge of the batter 206, the earphones 200 may have to be increased in size, which may also result in decrease in comfort for the user 102, especially for earbuds which are to fit inside the concha of the ear 104 and help the user 102 to sleep with the support of audio for at least eight or more hours.

In one or more embodiments, an advantage of the generative audio network 100 is the generation of generative audio 126 that may utilize substantially less memory 203, bandwidth or connectivity of the network 101A, and/or energy utilization of the battery 206. Specifically, a generative audio engine 220 may be utilized to provide generative audio 126 comprised of one or more generative features 120 to produce the sound 108. The generative audio 120 can be utilized for one or more purposes, including but not limited to: generation of an audioscape 118, including varying, dynamic, and/or randomized features; transition to a low-resolution version 162 emulating an audio track 152 that is a high resolution version 160; creation and use of generative features 120 as a masking feature 128 for producing masking sounds 109 for masking environmental sounds 106; and/or realtime dynamic generation of generative features 120 for managing ISO state of the user 102.

The earphone 220 may include a generative library 144 which may include information specifying how to generate generative features 120 on a digital signal processor 202 (Also referred to herein as the DSP 202). The DSP 202 may be integrated into a processor 201 of the earphone 200 and/or may be a distinct component of the earphone 200.

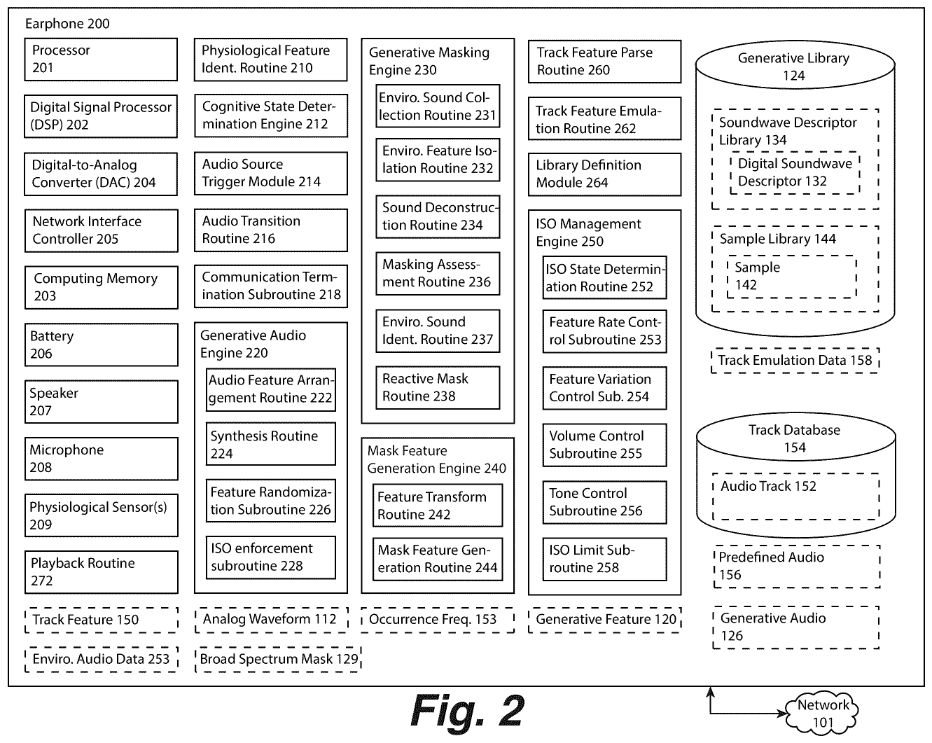

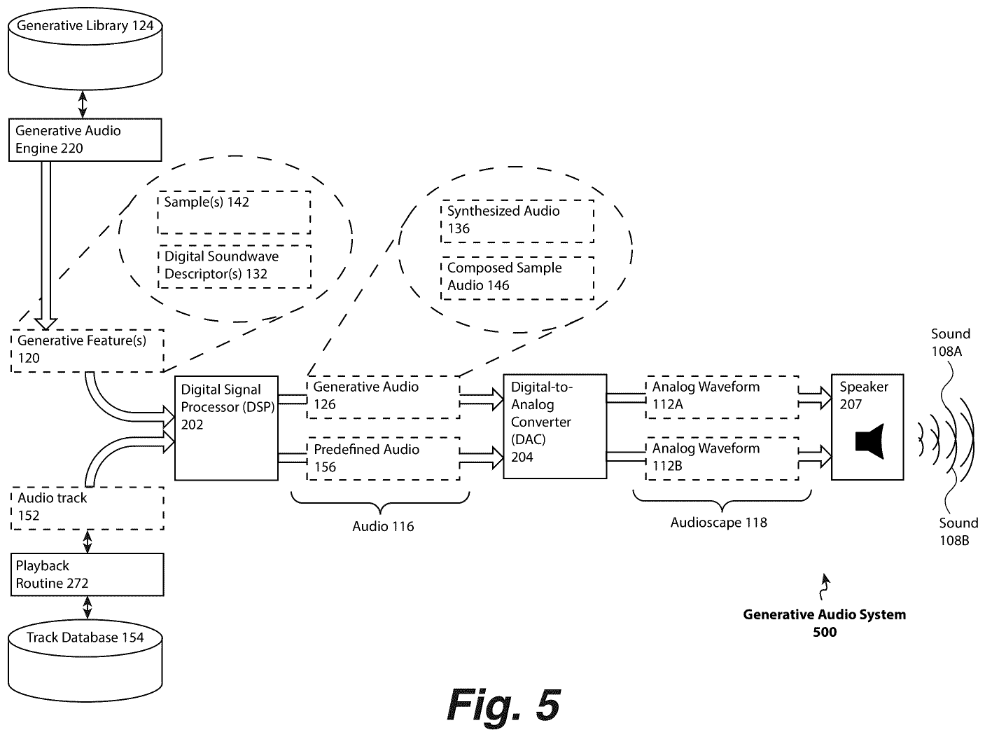

The generative audio engine 220 may produce and arrange the data specifying the generative features 120 to be sent to the DSP 202 for audio rendering. For example, and as shown and described in conjunction with FIG. 2, FIG. 5, and throughout the present embodiments, the DSP 202 may render both samples 142 composed by the generative audio engine 220 and/or digital soundwave descriptors 132 arranged by the generative audio engine 220. The composition and/or arrangement may be used to produce an audioscape 118, including randomization of generative features 120 therein; to reactively mask environmental sounds 106; to transition from high resolution versions 160 to low resolutions version 162; and/or to manage the ISO state of the user 102, for example with deliberately timed, managed, and/or constrained generative features 120.

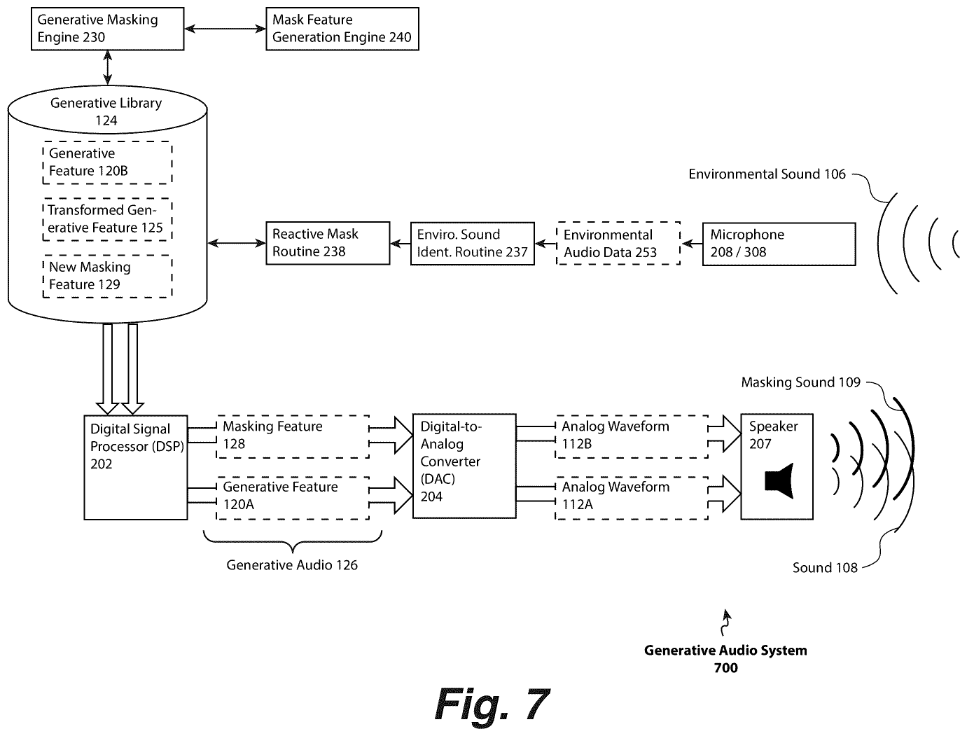

In one or more embodiments, the earphone 200 may include a generative mask engine 230. The generative mask engine 230 may include software code that when executing reactively masks one or more environmental sounds 106 with masking features 128, as shown and described in conjunction with FIG. 2 and throughout the present embodiments. In one or more embodiments, the earphone 200 may include a mask feature generation engine 240 (abbreviated “mask feature gen. engine 240” in FIG. 1), which may transform an existing generative feature 120 to a transformed generative feature 125 for increased utility in masking, and/or generate a new masking feature 128, as further shown and described in conjunction with FIG. 2, FIG. 7, and throughout the present embodiments.

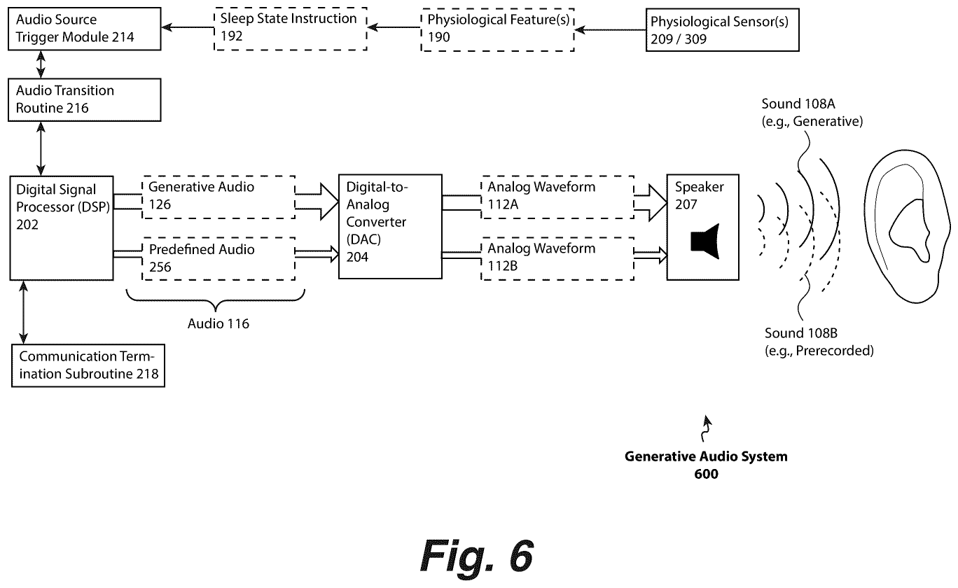

The earphone 200 may include an ISO management engine 250 which may evaluate an ISO state of a user 102 (including through use of physiological sensors 209, as shown and described in conjunction with FIG. 2, FIG. 6, and throughout the present embodiments) and/or manage the ISO state through the audioscape 118 and/or controlled instances of the generative audio 126, for example selectively timed, arranged, and/or constrained instances of the generative feature 120 extracted from the generative library 124.

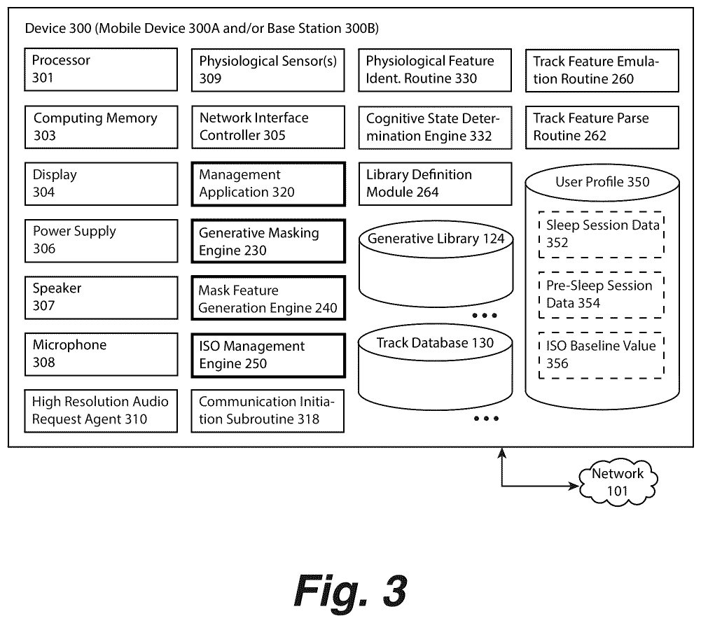

The device 300 may act as, with respect to the earphones 200: extended storage (e.g., a large computer readable memory), extended processing (e.g., more powerful processing with a large chipset and higher or relatively unlimited energy “budget”), sensing and/or extended sensing (e.g., gathering physiological data from the user 102; extended interfacing and control; gathering the environmental sound 106); back-end networking (e.g., communication with the server 400); and/or other purposes shown and described herein. A possible implementation of the device 300 is shown and described in detail in the embodiment of FIG. 3. In one or more embodiments, the device 300 may include a management application 320 which may allow the user 102 to select audio content, configure the earphones 200, set preferences for managing cognitive state or ISO state, etc. For example, the management application 320 may be an “App” running on a mobile device 300B, which may be controlled through a touchscreen interaction on the display 304 and/or through a voice interface. The device 300 may also include a track feature parse routine 260 and/or a track feature emulation routine 262, which may be utilized to parse an audio track 152 to generate an analogous low-resolution version 162 able to be rendered with the DSP 202, as shown and described through the present embodiments. The device 300 may also include a track database 150 from which the audio track 152 may be extracted and transferred to the earphone 200, and/or streamed from the device 300 to the earphone 200. The device 300 may include a user profile 350 for storing data related to the user 102 and usable in generatively rendering audio, for example sleep session data 352 which may determine when the user 102 is in the sleep state (e.g., which may be a trigger for initiating generative audio 126), and/or an ISO baseline value 356 against which physiological features may be measured to determine a current ISO state of the user 102.

It will be recognized that whenever an element, component, and/or process of a device 300 is shown or described herein, such element, component, and/or process of may occur in the mobile device 300B and/or the base station 300A. Reference to a “device 300” herein means either a single instance of an earphone 300, one of the base station 300A or the mobile device 300B, and/or both of the base station 300A and the mobile device 300B, unless where noted or required by context.

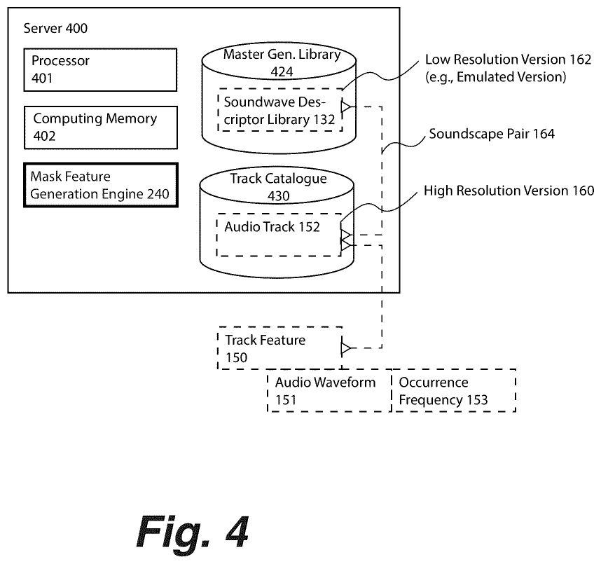

The earphone 200 and/or the device 300 may be further supported by a server 400, which may include one or more remote computing devices accessible over the network 101, for example the network 101B such as the internet. The server 400 may be utilized, with respect to the earphones 200 and/or the device 300, to further: extend storage (e.g., a large computer readable memory), extended processing (e.g., more powerful processing, parallel processing, specialized chip processing, etc.), and/or other purposes shown and described herein. For example, the server 400 may assist in what may be computationally intensive parsing of an audio track 152 into track features 150, translation into digital soundwave descriptors 132, and/or rebuilding of a generative library 124. The server 400 may also store extensive catalogs of content which can be downloaded to the device 300 and/or the earphones 200, for example the master generative library 424 and the track catalogue 430, as further shown and described in conjunction with the embodiment of FIG. 4.

FIG. 2 illustrates an earphone 200, according to one or more embodiments. The earphone 200 may be implemented as an earbud that may be fit into and held by the concha of the ear 104 or through other means of coupling in and/or to the ear 104. In one or more embodiments, the earphone 200 may include a processor 201, a digital signal processor 202 (also referred to as the DSP 202), a digital-to-analog converter 204 (also referred to as the DAC 204), a network interface controller 205 for communication with one or more devices over the network 101, a computer memory 203 (e.g., RAM, ROM, solid state computer readable memory), a battery 206, a speaker 207 (e.g., for delivering the sound 108 to an ear canal of the ear 104), a microphone 208, and/or one of more physiological sensors 209.

The processor 201 may include a microprocessor. The processor 201 may also include the DSP 202 and/or the DAC 204. For example, in one or more embodiments, the processor 201 is a QCC5171 chip, which includes an instance of the DSP 202 that is Kalimba DSP. The microphone 208 include an internal-facing microphone 208 which may gather sound within the ear 104 and which may assist in gathering physiological data, and/or may include an external microphone 208 which may assist in gathering physiological data (the sound of the user 102 breathing) and/or the environmental sound 106.

The DSP 204 may be configured to generate audio 116 for rendering (e.g., the DSP 204 may “render” audio tracks 152, samples 142, and/or digital soundwave descriptors 130). When rendering the digital soundwave descriptor 130, the DSP 202 may be synthesizing audio to result in the synthesized audio 136, as further shown and described in conjunction with FIG. 7. The DSP 204 may include a channel limit, which may be a number of simultaneous “channels” of audio and/or digital soundwave descriptors 132 that may be able to be simultaneously rendered as input sources.

The physiological sensors 209 may include sensors usable to determine physiological features from which a cognitive state and/or an ISO state can be determined. For example, the physiological sensors 209 may be configured to detect heart beats, respiration events, temperature of the user 102, and other physiological data. From this data, physiological features 190 may be able to be determined, for example respiration rate, respiration rate variability, heart rate, heart rate variability, temperature, rate of temperature change or temperature change variability, etc. In one or more embodiments, the physiological sensors 209 may include the microphone 208, an accelerometer, an inertial measurement unit (IMU), a thermometer and/or a thermal couple, and/or other sensors. Other devices may also contribute to sensing, including those coupled with the device 300 through the network, for example brainwave sensors, blood pressure sensors or monitors, etc.

The earphone 200 may include a traditional playback routine 272 configured to play prerecorded audio. The playback routine 272 may initiate playback of an audio track 152, for example an audio track 152 or playlist stored in the computing memory 203 and/or streamed from the device 300. The audio track 152 may be a monolithic audio track in .MP3, .MP4, .WAV, .M4A, .FLAC, .WMA, .AAC, and other commercially recognized digital audio formats. In one or more embodiments, the playback routine 272 may include computer readable instructions that when executed initiate sound 108 on a speaker 207 of an earphone 200 of a user 102, the sound 108 produced from an audio 116 comprising an audio track 152.

In one or more embodiments, the earphone 200 may include a physiological feature identification routine 210. The physiological feature identification routine 210 may be configured to assess physiological data (sound of the user 102, inertial data related to motion of the user 102, acceleration data, etc.) and utilize one or more techniques known in the art to determine one or more physiological features 190. The physiological feature identification routine 210 may also, or in addition, utilize the devices, systems, and/or methods shown and described in U.S. patent application Ser. No. 18/529,201, filed Dec. 5, 2023. Alternatively, or in addition, the physiological feature identification routine 210 may be stored on the device 300 and/or the server 400. In one or more embodiments, the physiological feature identification routine 210 includes computer readable instructions that when executed determine one or more physiological features of the user from physiological data received on one or more sensors (e.g., the physiological sensors 209) of the earphone 200.

In one or more embodiments, the earphone 200 may include a cognitive state determination routine 210 which may be configured to determine a cognitive state of the user 102, for example an awake state, a pre-sleep state, a sleep state, a non-rapid eye movement state of the sleep state (Non-REM state), and/or a rapid eye movement state of the sleep state (REM state). The sleep state may be referred to herein as the sleep state 192, and the awake state as the awake state 194, according to one or more embodiments. In one or more embodiments, the cognitive state determination routine 210 may simply receive the determination from else ware, for example affirmative feedback from the user 102, a communication from the device 300, etc. However, in one or more embodiments, the cognitive state determination routine 210 may utilize the physiological features 190 to determine cognitive state, for example by comparing default baselines and/or user-specific baselines of physiological features 190 to those actively sensed and extracted by the physiological sensors 209 and/or the physiological sensors 309. The cognitive state determination routine 210 may also, or in addition, utilize the devices, systems, and/or methods shown and described in U.S. patent application Ser. No. 18/529,201, filed Dec. 5, 2023, for determination of the sleep state 192. In one or more embodiments, the physiological sensors used to determine cognitive state may be in either or both of the earphones 200 or the device 300, and which may be referred to as the physiological sensors 209 and the physiological sensors 309, respectively. In one or more embodiments, the IMU of an earphone 200 may be sensitive enough to detect breathing of the user 102 and/or heart beats of the user 102, from which respiration rate, respiration rate variability, heart rate, and heart rate variability may be determined. The IMU data of the motion of the user 102 may be combined with sound data of the user 102 gathered by the device 300. Similarly, temperature of the user 102 (detected by sensors of the earphones 200) and temperature of the environment (detected by the sensors of the device 300) may be compared. In one or more embodiments, the cognitive state determination engine 212 may include computer readable instructions that when executed determine that a cognitive state of the user comprises a sleep state 192 based on the one or more physiological features 190.

In one or more embodiments, the audio source trigger module 214 may be configured to activate and/or deactivate the playback and/or rendering of audio 116 based on one or more events, for example the detection of a cognitive state, a change in cognitive state, an ISO state, and/or change in ISO state. In one or more embodiments, the audio source trigger module 214 may detect a cognitive state and/or ISO state and activate generative audio 126, deactivate predefined audio 156, activate predefined audio 156, and/or deactivate generative audio 126. For example, the audio source trigger module 214 may receive a call from the cognitive state determination engine 212 as to a sleep state specified by the sleep state data 192 and/or an awake state data 194 determined for the user 102. In one or more embodiments, the audio source trigger module 214 may include computer readable instructions that when executed initiate a generative audio 126 in response to a determination of the sleep state 192 of the user 102.

In one or more embodiments the earphone 200 may include audio transition routine 216. The audio transition routine 216 may be configured to, and optionally in condition with any initiation or termination effected by the audio source trigger module 214, transition between one or more audio sources and one or more other audio sources. For example, in one or more embodiments, audio transition routine 216 may include computer readable instructions that when executed fade the generative audio 126 into the audio 116 such that the audio 116 further comprises the generative audio 126. The audio transition routine 216 may also include computer readable instructions that when executed fade the audio track 152 out of the audio 116 such that the generative audio 126 replaces the audio track 152. This switch in source can reduce power consumption of the earphone 200 typically associated with playing the audio track 152, especially while streaming over a network 101 and/or from another device 300. The fade may occur over a set amount of time (e.g., 5 seconds, 10 seconds, 1 minute). In one or more embodiments, the fade may be partially completed, the cognitive state and/or ISO state of the user 102 evaluated or re-evaluated. If the cognitive state and/or ISO state maintain, then the fade may be allowed to proceed to completion. Where both the generative audio 126 and the audio track 152 are playing simultaneously, the speaker 207 may produce both the sound 108A and the sound 108B, e.g., concurrently and overlaid with generative features 120 and track features 150 closely aligned. Where the generative audio 126 is an emulated version of the audio track 152, the track features 150 may be overlaid and centered on any corresponding generative feature 120 such that the user 102 hears the combination of the track feature 150 (e.g., a high-resolution version 160) and its emulated generative feature 120 (e.g., the low-resolution version 162).

In one or more embodiments, the earphone 200 may include a communication termination subroutine 218, according to one or more embodiments. The communication termination subroutine may include computer readable instructions configured to terminate a communication channel, a communication connection, a network connection, and/or a communication session, between: (i) the earphone 200 and (ii) the device 300, the server 400, and/or the network 101. In one or more embodiments, the communication termination subroutine 218 may receive a call from the audio transition routine 216 as to when an audio track 152 or other data streamed to the earphones 200 for playing the audio track 152 is below a use threshold (e.g., a certain volume as played by the DSP 202) and/or is no longer playing. In one or more embodiments, the audio track 152 may be streamed to the earphone 200 with a wireless connection (e.g., the network 101A). In one or more embodiments, the communication termination subroutine 218 may include computer readable instructions that when executed, upon fading the audio track 152 out of the audio 116, terminate a wireless connection (e.g., Bluetooth®, WiFi, 5G), for example between the earphones 200 and the device 300. The audio track 152 may be streamed from a mobile device 300A communicatively coupled with the earphone 200, a base station 300B of the earphone 200 communicatively coupled with the earphone 200, and/or a computing device communicatively coupled to the earphone 200 (e.g., the server 400, a different computing device).

In one or more embodiments, the earphone 200 may include a generative audio engine 220. The generative audio engine 220 may include computer readable instructions that when executed produce generative audio 126 from one or more constituent elements (e.g., generative features 120). For example, generative features 120 may be produced, arranged, sequenced, timed, and/or modified, including as played samples 142 and/or rendered digital soundwave descriptors 132. The digital soundwave descriptors 132 may be a digitized mathematical, logical, and/or descriptive expression of a soundwave that can be turned into audio (e.g., by the DSP 202) and then sound 108. The generative audio engine 220 may further include computer readable instructions that when executed effect, enforce, or utilize digital rules related to the production, arrangement, sequencing, timing, and/or modification, and/or other generative qualities. As just one example, an audioscape 118 may include sounds of a forest which may help the user 102 to fall asleep. The generative audio 126 that the audioscape 118 is comprised of may include generative features 120, for example animal sounds such as a cricket sound, an owl sound, and/or a frog sound. Each of the generative features 120 may be implemented as a sample (e.g., the sample 142) and/or a digital soundwave descriptor 132, which may be organized into a soundwave descriptor library 134, as further described below. The generative features 120 may then be generated according to a pattern, a probability, and/or a specified occurrence pattern, and which may vary volume, stereo location (e.g., the left ear, the right ear, or a partial playing on each), tone, audio effects known in the art (e.g., echo, filters, modulation, reverb, delay, etc.), and/or other audio attributes and qualities. The soundwave descriptor library 130 may include instructions and/or rules for production of the associated audioscape 118. For instance, with regards to the sounds of the forest, the instructions may specify, for example, playing a frog sound with a certain probability, a cricket sound constantly but with periodic breaks, and overlaying a rare sound (e.g., seldom produced, or generated with a low probability), for instance an owl sound. In one or more embodiments, the production of the audiospace 118 may be timed with ISO state management and/or masking sounds (e.g., masking sounds 109), as shown and described throughout the present embodiments. The generative audio engine 220 may receive procedure calls and/or requests from additional computing systems, engines, routines, subroutines, and/or modules which may be evaluated with various priorities and then selectively produced and/or rendered.

Generative audio 126 may include either synthesized audio 136 and/or composed sample audio 146. Synthesized audio 136 may be audio synthesized from the DSP 202 from descriptors of sounds such as the digital soundwave descriptors 130. In contrast, composed sample audio 146 includes one or more samples 142 (e.g., .mp3, .m4A, .WAV) arranged and/or composed. In one or more embodiments, the generative audio 126 comprises a synthesized audio 136 that includes audio produced from one or more digital soundwave descriptors 132. In one or more embodiments, the generative audio 126 includes audio produced from a set of two or more sound samples 142 that may be composed such that the set of two or more sound samples 142 are sequenced and/or overlayed (e.g., according to an arrangement and/or composition, which may be specified, random, and/or determined according to additional rules or instructions).

In one or more embodiments, the generative audio engine 220 may include an audio feature arrangement routine 222, a synthesis routine 224, a feature randomization subroutine 226, and/or an ISO enforcement routine 228.

The audio feature arrangement routine 222 may include computer readable instructions that when executed arrange and/or compose one or more samples 142 and initiate playback of each according to the arrangement and/or composition. In one or more embodiments, the audio feature arrangement routine 222 may include computer readable instructions that when executed initiate sound 108 on a speaker 207 of an earphone 200 of a user. 102, the sound 108 produced from an audioscape 118, where the audioscape may include one or more audio features (e.g., the generative features 120, and specifically the sample feature 140) extracted from a generative library 124). The generative library 124 may include two or more generative features 120 arrangeable in real time to produce the audioscape 118, for example from arranging and playing the samples 142.

The synthesis routine 224 may be configured to receive descriptions of sounds and submit the descriptions for rendering, for example on the DSP 202. In one or more embodiments, the synthesis routine 224 may include inputting the one or more digital soundwave descriptors 132 into a DSP 202 of a microprocessor of the earphone 200 (e.g., the processor 201). In one or more embodiments, the DSP 202 may then transmit an audio waveform rendered by the DSP 202 to the DAC 204. The synthesized audio 136 may then be generated by an analog waveform 112 of the audio waveform transformed by the DAC 204 and transmitted to the speaker 207 of the earphone 200, according to one or more embodiments.

The feature randomization subroutine 226 may be configured to randomize production of one or more generative feature 120 within the audioscape 118. For example, the feature randomization subroutine 226 may call the processor 201 for random numbers and/or pseudorandom numbers with respect to one or more generative features 120 within the generative library 124 to determine if, or when, the generative features 120 are to be rendered. As one example, in a musical 4:4 time, on the occurrence of each potential beat, a call may be made as to whether a certain generative feature 120 is rendered, where the probability is 40% and the pseudorandom number determines whether the render is to occur. In one or more embodiments, the feature randomization subroutine 226 includes computer readable instructions that when executed randomize occurrence of a generative feature 120 within the audio played on the speaker 207 of the earphone 200.

In one or more embodiments, the generative audio engine 220 may render (or refrain from rendering) generative features 120 according to the input and/or feedback from one or more other systems, routines, subroutines, modules, etc. For example, rendering limits and/or constraints may be placed on the generative audio engine 220. In one specific example, the DSP 202 may have a channel limit which may limit the number of sources and/or types of audio which can be simultaneously rendered, and the generative audio engine 220 may enforce rendering within those limits. As described below, the ISO limit subroutine 258 may set an ISO limit value in the computing memory (e.g., the memory 203), which may establish a feature limit for production of a sound 108 associated with the generative feature 120 within a time period or other measurable progressive state function (e.g., number of generative features 120 rendered from an inidial index value). In one or more embodiments, the ISO enforcement subroutine 228 may include computer readable instructions that when executed, upon determination that an environmental sound 106 has been collected by the microphone 208 (for which active masking as been specified, as further described below), querying the ISO limit value, e.g., within the memory 203. In one or more embodiments, the ISO enforcement subroutine 228 may further include computer readable instructions that when executed determine production of the sound 108 associated with the generative feature 120 is within the ISO limit value prior to playing the generative feature 120. For example, in the audioscape 118 example of a forest, the ISO limit value may be set such that sounds above a certain tone threshold cannot be rendered more often than once per five seconds and persist no longer than one second; the frog sound represented by a generative feature 120 may therefore be constrained such that it does not play to violate the ISO limit.

In one or more embodiments, the earphone 200 may include a generative masking engine 230. The generative masking engine 230 may be configured to collect an environmental sound 106, determine how to mask the environmental sound 106, and allocate an audio element (e.g., a generative feature 120) to mask the environmental sound 106. The generative masking engine 230 may also be configured to detect the environmental sound 106 (which may be substantially similar to the original environmental sound 106 used to allocate and generate the masking sound 109) and reactively mask the environmental sound 106 by playing a masking sound 109.

In one or more embodiments, the generative masking engine 230 may include an environmental sound collection routine 231, an environmental feature isolation routine 232, a sound deconstruction routine 234, a masking assessment routine 236, an environmental sound identification routine 237, and/or a reactive mask routine 238, according to one or more embodiments. In FIG. 2 and throughout the present embodiments and figures, environmental may be abbreviated as “enviro.”

In one or more embodiments, the environmental sound collection routine 231 may be configured to generate audio from environmental sound 106 collected on the microphone 208, and, for example, store the audio for analysis in the memory 203 and/or the memory 303. In one or more embodiments, the environmental sound collection routine 231 may include computer readable instructions that when executed collect a first instance of the environmental sound 106 from an environment of the user 102 (e.g., a room and the sounds audible from outside, an outdoor area in which the user 102 is present, a transportation vehicle the user 102 is riding within, such as a bus or subway car, etc.), and storing the environmental sound 106 as an environmental audio data 233. The environmental sound 106 may have been collected on a microphone 208 of the earphone 200 and/or on a microphone 308 of a device 300 communicatively coupled to the earphone 200. The environmental audio data 233 may then be parsed and/or analyzed to determine features that may need to be masked, for example recurring tones, noise, or sounds within the environment of the user 102. Such features may be referred to as “environmental features.”

The environmental feature isolation routine 232 may be configured to isolate one or more environmental features from the environmental audio data 233. For example, there may be a recurring pattern of beeping, a dog barking, a train passing, alarming, or other sounds. Environmental features may be isolated at varying levels of granularity. For example, the environmental sound can be deconstructed into frequency bins, each of which may be specified as an environmental features. Alternatively, or in addition, soundwave analysis can be performed. Various technique known in the art may be used to identify and isolate individual complex waveforms for further characterization, including without limitation sound pattern recognition, which may utilize similar technology and/or techniques to voice recognition. The device 300 may assist in computational and memory resources for providing initial isolation, and optionally producing “shorthand” recognition data usable to rapidly identify the environmental feature. In one or more embodiments, the environmental feature isolation routine 232 includes computer readable instructions that when executed isolate an environmental feature of the environmental sound 106 from the environmental audio data 233. The environmental feature of the environmental sound 106 may include an audio waveform of the environmental sound 106 that includes a plurality of waves, each of which may be mathematically expressible.

In one or more embodiments, the sound deconstruction routine 234 may be configured to deconstruct the audio waveform into one or more waves (e.g., descriptions of waves) that may approximate the soundwave of the environmental feature. In one or more embodiments, the sound deconstruction routine 234 may include computer readable instructions that when executed decompose the audio waveform of the environmental sound 106 into two or more waves that are an approximation of the audio waveform of the environmental sound 106, and where each wave of the two or more waves may include a soundwave frequency and a soundwave amplitude, e.g., that may be used to describe the waves. In one or more embodiments, decomposition of the audio waveform may include application of a Fourier transform (and/or fast Fourier transform or Fast Fourier Transform (FFT)) and identification of one or more dominant frequency bands within the environmental audio data 233.

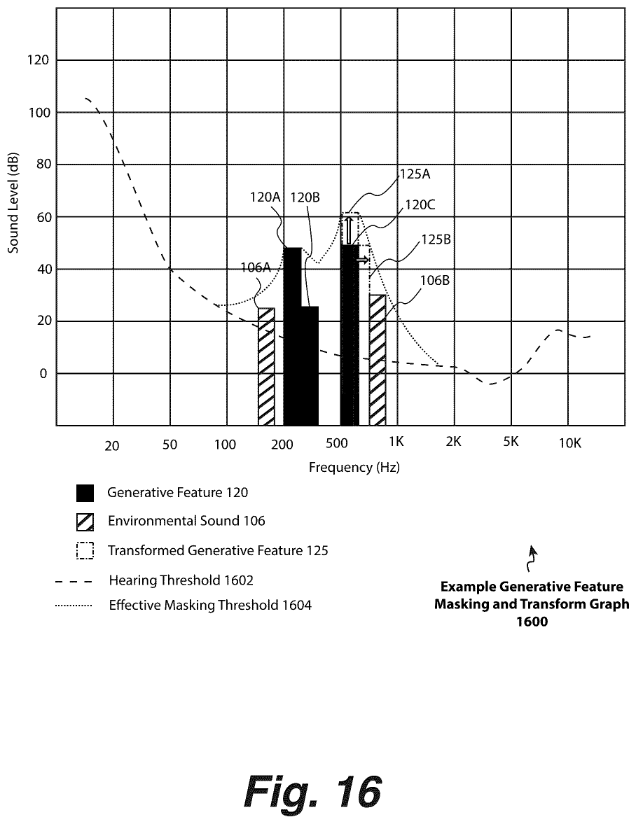

A masking assessment routine 236 may be configured to assess masking potential of one or more audio features to mask the environmental sound 106. Many audio features can be evaluated for masking, for example a generative feature 120, a synthesized feature 130 (e.g., generated from a digital soundwave descriptor 132), and/or a sample feature 140 (e.g., generated from a sample 142). In one or more embodiments, the masking assessment routine 236 may determine whether at least one of the two or more generative features 120 of the generative library 124 meets a masking threshold for the audio waveform of the environmental sound 106, e.g., the audio waveform that may be identified and/or extracted from the environmental audio data 233. One or more techniques known in the art may be utilized to determine masking capability of one sound by another with regard to the human ear and auditory cerebral processing capability. For example, it is known in the art that masking a sound for a person such as a user 102 can be effective even if a masking sound (e.g., the masking sound 109) is generated rapidly after the environmental sound 106 intended to be masked (e.g., within tens of milliseconds) due to the delay in cerebral processing of the human brain. Similarly, both frequency (tone) and amplitude (volume) may have an impact on masking and its delay. An example of an effective masking determination, including application of one or more of the present embodiments, is shown and described in conjunction with the embodiment of FIG. 16.

The masking assessment routine 234 may be configured to check against several sources of potential masking audio before either selecting a masking audio, transforming a masking audio, and/or generating a new masking audio. In one or more embodiments, the masking assessment routine 234 includes computer readable instructions that when executed compare one or more attributes of the audio waveform of the environmental sound 106 with one or more attributes of an audio waveform of at least one of the two or more generative features 120 within the generative library 124. For example, the comparison may be made in an attempt to find a masking feature 128 within the generative library 124.

The masking assessment routine 234 may be configured to assess potential generative features 120 in an order of priority, for example: (i) existing within the generative library 124, (ii) transformable from a generative feature 120 within the generative library 124, and (iii) able to be generated (and rendered) within the capabilities of the DSP 202. The masking assessment routine 234 may include computer readable instructions that when executed determine that the two or more generative features 120 of the generative library 124 are insufficient to mask the environmental sound 106 (e.g., below a masking threshold needed for an effective sound mask, determined to be an ineffective mask, etc.). Where no generative feature 120 that is an effective mask is preexisting, the masking assessment routine 234 may generate a call to the mask feature generation engine 240 for transformation of a generative feature 120 for use as the masking feature 128 and/or generation of a new masking feature 128 “from scratch”, according to one or more embodiments. Once an effective masking feature 128 is identified, the masking feature 128 may be stored in the memory 203 for efficient retrieval (e.g., within RAM or solid state memory). If the device 300 was utilized in analyzing or otherwise determining the effective masking feature 128, the audio for the masking feature 128 may be communicated to the earphones 200 (e.g., over the network 101A) for storage and if needed rapid access.

It will be appreciated that in one or more embodiments, identification of sound within certain frequency bins may be reactively responded to following feature isolation (e.g., via the feature isolation routine 232) without previous collection, assessment, and/or storage of designated masking features 128. Alternatively, or in addition, the generative library 124 may be designed such that masking features 128 for common noise frequency bins are included.

In one or more embodiments, the generative masking engine 230 may be configured to identify environmental sounds 106 and rapidly respond to mask the environmental sounds 106 and any environmental features thereof. In one or more embodiments, the environmental sound identification routine 237 may be configured to detect and/or identify an environmental sound 106, for example a noise that could distract the user 102 or make it harder for the user 102 to rest or sleep. In one or more embodiments, the environmental sound identification routine 237 includes computer readable instructions that when executed determine the environmental sound 106 has been collected by the microphone 208 of the earphone 200. In one or more embodiments, the reactive masking routine 238 may be configured to rapidly play the masking feature 128 upon determination that the corresponding and/or associated environmental sound 106 has been detected and identified. The reactive masking routine 238 may include computer readable instructions that when executed generate the masking sound 109 (e.g., from the masking feature 128) to mask the environmental sound 109 by playing a generative feature 120 (e.g., acting as the masking feature 128 in the present example) on the speaker 207 of the earphone 200.

The mask feature generation engine 240 may be configured to generate one or more masking features 128, for example following a determination that existing masking features 128 may be insufficient and/or unavailable. The masking feature generation engine 240 may include a feature transform routine 242 and/or a mask feature generation routine 244. The feature transform routine 242 may be configured to transform an existing generative feature 120 (e.g., a synthesized feature 130 and/or a sample feature 140) in order to generate an effective masking feature 128. The transformation can be effected in real time. For example, where the masking feature 128 is just outside of the effective masking threshold 1604, as shown and described in conjunction with FIG. 16, the frequency of a generative feature 120 and/or an amplitude of the generative feature 120 may be dynamically and in real time transformed to within tolerance for effective masking.

In one or more embodiments, the feature transform routine 242 may include computer readable instructions that when executed apply a frequency transformation and/or an amplitude transformation to the audio waveform of at least one of two or more generative features 120 (e.g., stored or organized within the generative library 124), to create a low-power masking sound 128 within the audioscape 118 of the generative library 124. In one or more embodiments, the mask feature generation routine 244 includes computer readable instructions that when executed generate a new instance of the generative feature 120.

In one or more embodiments, any transformed and/or new generative features 120 that may act as the masking feature 128 may be optionally added as new data within the generative library 124. In one or more embodiments, a library definition module 264 may include computer readable instructions that when executed add the new instance of the generative feature 120 to the generative library 124 as a masking feature 128. Depending on the environment of the user 102 and configuration of the earphones 200 and/or device 300, excess data may be later removed for memory efficiency periodically, e.g., once the user 102 is no longer within the environment, and/or when the user 102 is determined to be in an awake state (e.g., following a sleep session of the user 102). In such case, the library definition module 264 nay remove the new instance of the generative feature 120 from the generative library 124 upon termination of a sleep session of the user 102.

The library definition module 264 may be configured to store one or more generative features 120 within an associated database collection as a generative library 120. For example, the generative library 124 may have a coherent theme (e.g., wind chimes, sounds of the coast, sounds of a busy café), and/or may be organized according to other principles for case of query (e.g., audio producing sounds that easily mask certain frequency bands and/or routines of environmental sound 106). The library definition module 264, as further shown and described in conjunction with the embodiment of FIG. 3, may also allow of compilation or assembly of unique libraries that may suit the preferences or needs of the user 102. For example, to aid in sleep or relaxation the user 102 may have a preference for the sounds of a train dining car, and custom assemble or select a set of generative features 102 encoding both train noises and restaurant dining noises. The library definition module 264 may also store temporary and/or permanently added generative features 120, for example that have been transformed or generated to act as masking features 128 within a certain environment of the user 102. There may be multiple instances of a generative library 124 stored on the earphone 200 and/or the device 300 (although for brevity and clarity of explanation, only one is shown in each of FIG. 2 and FIG. 3). The generative library 124 may be comprised of one or both of the soundwave descriptor library 124 and the sample library 144.

In one or more embodiments, the library definition module 264 may include computer readable instructions that when executed generate a soundwave descriptor library 132 that includes one or more instances of the digital soundwave descriptor 134, and transmit and/or receive the soundwave descriptor library 134 on the earphone 200 and/or store the soundwave descriptor library 132 in a computing memory 203 of the earphone 200. The generative audio 126 may then be extracted from the soundwave descriptor library 132 stored on the computing memory 203 of the earphone 200, for example as one or more generative features 120 generated from digital soundwave descriptors 132.

In one or more embodiments, the earphone 200 may store one or a few instances of the generative library 124, with any additional instances stored on the device 300 to act as an expanded computing memory. When the user 102 makes a selection of a generative library 124 that they would like to listen to, if that generative library 124 is not present in the memory 203, the selected generative library 124 may be requested and uploaded from the device 300 (and/or the server 400) to the memory 203, for example over the network 101A and/or the network 101B. Following upload, a network connection may be terminated.

In one or more embodiments, generative libraries 124 may emulate an audio track 152, providing a mathematical description of the audio track at reduced and/or compressed memory space. As a straightforward example, where a typical .MP3 file 60-80 kbytes per second, even when coding for a simple drum beat, a mathematical description of the drum beat combined with a description of its occurrence frequency would create a substantially smaller data size. In more complex examples, an. WAV or .MP3 file containing two or more identifiable features (e.g., the track feature 150) may be analyzed for extraction of the two or more identifiable features, or a subset thereof. The identified and extracted track features 150 may be used to define generative features 120 such as a synthesized feature 130 (from digital soundwave descriptors 132 as approximations of each track feature 150) and/or sample features 140 (e.g., the track feature 150 extracted and “cleaned up” through audio processing to remove any other, overlapping track features 150) or extraneous audio.

In one or more embodiments, and as further shown and described in conjunction with the embodiment of FIG. 4, an audio track 152 may include an associated generative library 124. The association may enable: (i) a user 102 to switch between a human-produced and arranged audio track 152 and a randomly generated and/or procedurally generated generative library 124, where each have generally the same sounds or emulated sounds; (ii) switch between a high resolution version 160 (e.g., typically the audio track 152) and a low resolution version 162 (e.g., typically generative audio 126 comprised of generative features 120); and/or (iii) reactively mask environmental sound 120 within the “canon” or style of the audioscape 118. In some cases, the audio track 152 may have been specially produced, for example to aid in or reduce ISO state, or conversely to aid in elevating ISO state (e.g., getting the user 102 more excited for a physical work out). The associated generative library 124 may be specially created and tested for its accuracy in emulating the audio track 152, for example by the same content team and/or creative team which produced the audio track 152. However, in one or more embodiments, the audio track 152 may have no given pair, and may be parsed to result in a generative library 124 emulating the audio track 152, as further shown and described throughout the present embodiments.

In one or more embodiments, a track feature parse routine 260 may be configured to parse an audio track 152 to isolate individual track features 150 for further evaluation, for example to be turned into analogous and/or emulating generative features 120.

In one or more embodiments, the track feature parse routine 260 includes computer readable instructions that when generated parse the audio track 152 to determine a track feature 150 of the audio track 152 comprising an audio waveforms of the track feature 150 and an occurrence frequency the audio waveform of the track feature 150 (e.g., a periodicity of occurrence, a probability of occurrence, and/or another method know in the art for description of occurrence of the track feature 150 within the audio track 152). The audio waveform of the track feature 150 may include one or more waves each comprising a soundwave frequency and soundwave amplitude. The track features 150 may then be utilized to define generative features 120 that can be used to minimize memory storage, create random or procedurally generated audioscapes 118, and/or reactively mask environmental sound 106. In one or more embodiments, the track feature emulation routine 262 may include computer readable instructions that when executed generate a generative feature 120 including an audio waveform of the generative feature 120, for example for each track feature 150. The library definition module 264 may store a generative library 124 with the resulting generative features 120 and optionally associate the generative library 124 with the audio track 152. The association may be effected by storing a pointer from the generative library 124 to the audio track 152 or track database 154, or vice versa (e.g., including the location or name of the audio track 152 within the generative library 124, and/or storing a unique identifier of the generative library 124 in association with the audio track 152, such as in metadata or a separate database of the device 300).

Depending on the capability of the DSP 202 to accept, mix, and produce generative audio 126 from generative features 120, the generative features 120 may need to be controlled, audibly separated, and/or their simultaneous or overlapping rendering restricted. For example, the DSP 202 may include a channel limit for the number of audio source inputs and/or generative features 102 that can be rendered simultaneously. In one or more embodiments, the track feature emulation routine 262 may include computer readable instructions that when executed generate a generative feature 120 including an audio waveform of the generative feature 120, the audio waveform of the generative feature including a set of one or more waves within a channel limit of the DSP 202. The audio waveform of the generative feature 120 may approximate the audio waveform of the track feature 150 within the channel limit of the DSP 202. For example, where the channel limit is six, the track feature emulation routine 262 may be configured to ensure that at most six channels are utilized simultaneously. As another example, one channel of the DSP 202 may be reserved for playing the audio track 152 (e.g., received from the playback routine 272), one channel reserved for reactive masking (e.g., generating masking audio 126), and four channels for emulating the audio track 152. Including channels for both the audio track 152 and the emulation of the audio track 152 may enhance transitioning between the audio track 152 and an emulated version of the audio track 152 implemented by the generative library 124.

In one or more embodiments, the earphones 200 may include an ISO management engine 250 configured to determine an ISO state of a user 102 and/or control generation of sound 108 for the user 102 based on the ISO state of the user 102. For example, the ISO management engine 250 may be configured to control the tempo, tone, diversity, and repetitiveness of sounds 108 produced by the user 102. The ISO management engine 250 may include one or more of an ISO state determination routine 252, a feature rate control subroutine 253, a feature variation control subroutine 254, a volume control subroutine 255, a tone control subroutine 256, and/or a ISO limit subroutine 258, according to one or more embodiments.

In one or more embodiments, the ISO state determination routine 252 may include computer readable instructions that when executed determine that the ISO state of the user 102 at one or more times (e.g., a first time, a second time). The ISO state may be determined and expressed as either a numerical value representing the ISO state (e.g., determined based on numerical values assigned to physiological feature(s)) and/or a discrete ISO state (e.g., “excited”, “normal,” “calm”). In one or more embodiments, the ISO state determination routine 252 may include computer readable instructions that when executed determine that the ISO state of the user 102 includes a heightened ISO state based on one or more physiological features determined based on the physiological indicators collected at the first time. The one or more physiological features may include a heart rate of the user 102, a heart rate variability of the user 102, a respiration rate of the user 102, a respiration rate variability of the user 102, and/or a temperature of the user 102 (e.g., and/or a “resting” temperature of the user 102 relative to an ambient temperature of the environment, and/or a temperature of the user 102 relative to motion of the user 102 as may be determined through an inertial measurement unit, or IMU). The ISO state determination routine 252 may include computer readable instructions that when executed generate on a speaker 207 of the earphone 200 a sound 108 from an audio, where the audio may include two or more generative features 120 extracted from a generative library 124, for example stored on a computing memory 203 of the earphone 200. In one or more embodiments, the audio may include two or more generative features 120 each including one or more digital soundwave descriptors 132 extracted from a soundwave descriptor library 134 stored on the computing memory 203 of the earphone 200. In one or more embodiments, the ISO management engine 250 may call the generative audio engine 220 for rendering of audio and/or send data specifying values for the ranges of tone, tempo (e.g., feature rate), sound diversity (e.g., feature variation), and other attributes or limitations of music or sound to be produced.

In one or more embodiments, the feature rate subroutine 254 may include computer readable instructions that when executed set a feature rate that may specify a tempo and/or minimum or maximum occurrence frequency within a given time period of generative features 120 that can be rendered. The two or more generative features 120 may then be rendered at a first rate matching the ISO state of the user 102 at the first time. The two or more generative features may be rendered with the DSP 202 of the earphone 200 and a DAC 204 of the earphone 200. In one or more embodiments, the feature rate subroutine 254 may include computer readable instructions that when executed reduce the first rate to a second rate of generative features 120 rendered that is slower than the first rate, for example in response to determining the user 102 is currently at or has achieved an ISO state matching the first rate of generation of the generative features 120. Physiological features may be continually and/or periodically assessed (e.g., as determined from physiological sensors 209) and the ISO state continually and/or periodically adjusted to “guide” the user 102 into raising, lowering, and/or maintaining an ISO state according to set user 102 preferences. For example, to aid in sleep, a default sleep setting may target a certain lower (e.g., calm) ISO state that may be a percentage that is a portion of a baseline ISO value 356 for the user 102. In one or more embodiments, the feature rate control subroutine 254 may include computer readable instructions to maintain the second rate of generative feature production (which may be slower than the first rate), to adaptively manage the ISO state of the user 102. Especially where generative features 102 are utilized, the ISO management may occur at reduced power and memory of the earphone 200, for example compared with changing between audio tracks. In one or more embodiments, use of a soundwave descriptor library 134 compared with a sample library 144 may save yet more memory and/or processing of the earphone 200.

In one or more embodiments, the feature variation control subroutine 253 may be configured to control the number of generative features permitted to be rendered within a time period, and/or a tempo of generative rendering of the DSP 202. In one or more embodiments, the feature variation control subroutine 253 may include computer readable instructions that when executed reduce a number of generative features 120 (e.g., the “feature variation”) permitted to be rendered within the generative library 124 (such as the soundwave descriptor library 134) upon a determination of the reduced ISO state of the user 102.

Similarly, in one or more embodiments, the volume control subroutine 254 may be configured to control volume (and/or audio wave amplitude) of the generative features 120. In one or more embodiments, the volume control subroutine 254 may include computer readable instructions that when executed reduce volume of at least one of the two or more generative features 120 rendered from the soundwave descriptor library 134, for example upon the determination of the reduced ISO state of the user 102 and/or to attempt to lower reduce the ISO state of the user 102.

In one or more embodiments, a tone control subroutine 256 may be configured to limit the tone of one or more generative features 120. For example, the tone control subroutine 256 may apply a filter to the samples 142 of the sample library 144 and/or the digital soundwave descriptors 132 of the soundwave descriptor library 134. Thereafter, the generative audio engine 220 may only produce generative audio 126 that includes those generative features 120 passing through the selection filter. In another example, any generative features 120 above the tone limit may be transformed to be below the tone limit. For example, within a “sounds of the forest” instance of the audioscape 108, the sounds of owls may be transformed to reduce tone below a tone limit-such newly transformed generative feature 120 which will generally continue to be recognized as an owl sound by the user 102. Alternatively, or in addition, the entire generative library 124 can be shifted. In one or more embodiments, the tone control subroutine 256 may include computer readable instructions that when executed lower a tone of at least one of the two or more generative features 120 rendered from the soundwave descriptor library 132 upon the determination of the reduced ISO state of the user 102 and/or to attempt to lower reduce the ISO state of the user 102.

The ISO management engine 250 may include an ISO limit subroutine 258 which may be configured to set an ISO limit value in the computing memory 203, either for tone, tempo, variation, and/or volume. For example, the ISO limit subroutine 258 may include computer readable instructions that when executed establish a feature rate limit for production of a sound 106 associated with the generative feature 120 within a time period. The ISO limit subroutine 258 may store and periodically update the ISO limit value in the memory 203 accessible to the ISO enforcement subroutine 228, as further described above.

It will be recognized that tone control, feature limit, and feature variation may result in complex and combined criteria for ISO state management. For example, all generative features with certain tones may be selected for feature variational limit, e.g., such that only one or a few generative features 120 with high tones are included within the audioscape 118, and are also limited in their occurrence per time period and/or have a reduced occurrence probability relative to other, lower-toned generative features 120.

In one or more embodiments, reactive masking may occur within the constraints of the ISO limit value. For example, the ISO enforcement routine 228 may be configured to rapidly check whether generation of a proposed masking sound 109 would violate the ISO limit value. In one or more embodiments, the ISO enforcement routine 228 may include computer readable instructions that when executed determine production of a masking sound 109 is within the ISO limit value based on one or more rendered generative features. For example, if too many generative features 120 have been recently rendered, the masking feature 128 be inhibited from generation and therefore the masking sound 109 not produced for the ear 104 of the user 102.

The earphone may include one or more generative libraries 124. Each generative library 124 may include either or both of a soundwave descriptor library 134 and/or a sample library 144. The generative library 124 may be comprised of elements usable to create generative features 120 for the generative audio 126. The generative features 120 may be organized within a data structure according to many possible organizational principles. For example, generative features 120 may be categorized or organized for rapid query, where any known or likely masking features 128 may be stored in a rapidly accessible memory location. In another example, generative features 120 may be organized and stored by probability of occurrence, such that random selection of a given hierarchical level of organization (e.g., a folder within a file system) can result in generating one generative feature 120 specified under such selected level of organization. The generative library 124 may include metadata such as tags, a description of the generative features 120 included within the generative library 124, and/or data specifying one or more associated audio tracks 152 (e.g., which the generative library 124 may emulate, and/or which the generative library 124 may have been determined or selected as a good transitionary replacement upon detecting a trigger event such as the user 102 falling asleep).

The earphone 200 may store the track database 154 comprised of one or more audio tracks 152 (e.g., a song, a podcast, a series of sound effects and/or soundscape, etc.). In one or more embodiments, the earphones 200 may store on the memory 203 only those audio tracks 144 likely to be played, such that the earphones 200 may not need to stream the audio track 152 from the device 300. However, in one or more embodiments, it will be recognized that the track database 154 can be stored, in its entirety, on the device 300 and/or the server 400 and streamed to the earphones 200 on-demand. As further shown and described in conjunction with the embodiment of FIG. 4, there can exist extensive catalogs of audio tracks 152 that may be downloaded to the device 300 and/or the earphones 200, e.g., over the network 101.

In one or more embodiments, it will be recognized prerecorded audio 156 may be combined with generative audio 126 to create a comprehensive and/or dynamic audioscape 118. For example, the prerecorded audio 156 may include music, whereas the generative library 124 may include sound effects (e.g., “sounds of the desert”) rendered over the music. Even if the music switches to a next track (e.g., an audio track 152A changes to the audio track 152B), the same sound effects may be maintained to create continuity and/or control ISO state between and among a playlist of audio tracks 152 which otherwise may have varying tones, tempos, and/or instrument variation. In one or more embodiments, an advantage includes the ability to provide continuity between and among predefined audio 156 by utilizing generative audio 126 combined or overlaid therewith. This advantage further extends to the ability to transition off of predefined audio 156 while maintaining the generative audio 126 at reduced power and memory. It should be noted that although looping short portions of prerecorded audio is possible without a network connection, such looped portions may have no generative control or flexibility, and may be easily detected by a cognition of the user, which can result in inhibiting rest or sleep due to its repetition and any artifacts of transition in the loop.

FIG. 3 illustrates the device 300, according to one or more embodiments. The device 300 may be communicatively coupled to the earphones 200 (including the earphone 200L and/or the earphone 200R), one or more servers 400, and/or one or more additional devices, through one or more networks 101 (e.g., the network 101A, the network 101B, etc.). The device 300 may include a mobile device 300A and/or a base station 300B having data processing and/or computing capability. The mobile device 300A may be, for example, a smartphone (an Android® phone, an iPhone, another smartphone) and/or a tablet device. In one or more other embodiments, the device 300 is and/or may include a base station 300B which may be used for docking, charging, storing, and/or protecting the earphones 200, especially where the earphones 200 are implemented as earbuds. The base station 300B may include its own voice or graphical interface, and/or may additionally rely on utilizing the display 304 of a mobile device 300A as an interface for configuration and control. In one or more embodiments, the earphones 200 may be supported by and/or communicatively coupled with both the mobile device 300A and the base station 300B, and the elements shown and described in conjunction with the embodiment of FIG. 3 may be allocated among the mobile device 300A and the base station 300B, and/or exist on both.

The device 300 may include a processor 301 (e.g., a microcontroller, a computer processor, etc.), a computing memory 303 (e.g., RAM, solid state memory, etc.), a display 304 (e.g., an LCD display, an OLED display, a micro LED display), a network interface controller 305 (e.g., supporting one or more wireless protocols, such as Bluetooth® and/or WiFi), a speaker 307, a microphone 308, and/or one or more physiological sensors 309.

The device 300 may include a high resolution audio request agent 310 that may be configured to receive a request for high resolution version 160 of audio to be used by the earphones 200, for example an audio track 152 to be uploaded to the memory 203 of the earphones 200 and/or streamed to the earphones 200. As just one example, the high resolution audio request agent 310 may receive a remote procedure call over the network 101B when a trigger event occurs such as the user 102 awakening, which may then initiate the transition from generative audio 126 to predefined audio 156. In one or more embodiments, the device 300 may include a communication initiation subroutine 318 which may be configured to ping and/or establish a wireless connection with the earphones 300 for transmission of substantial data, for example over the network 101B.

In one or more embodiments, the device 300 may include a management application 320. The management application 320 may be configured to control, manage, configure, and/or select preferences for the earphones 200 and functionality thereof. For example, the management application 320 may be utilized to download and manage generative libraries 124, manage preferences for generative features 120 (e.g., silencing a particular generative feature 120 the user 102 does not wish to hear or wishes to deemphasize). The management application 320 also may be utilized to download and manage track databases 154 and audio tracks 152 (e.g., playlists, music, podcasts, guided meditations, etc.). In addition, the management application 320 may be utilized to configure masking control, setting triggers for playing various audio (including generative audio 120 and predefined audio 156, and/or high resolution versions 160 and low resolutions versions 162), which generative features 120 within the generative audio 126 are to be rendered or inhibited, and rudimentary controls such as master volume of the sound 108, play speed of the audio track 152, etc. In one or more embodiments, where the device 300 is or includes the mobile device 300A, the management application 320 may be instantiated as and/or include a mobile application (a “mobile app”). The management application 320 may be communicatively coupled with the server 400, for example to allow for authentication and download of data resources from the server 400.

The device 300 may include any of the engines or other computer readable instructions shown and described in conjunction with the embodiment of FIG. 2, for example the generative masking engine 230, the mask feature generation engine 240, and/or the ISO management engine 250. In one or more embodiments, the engines or other computer readable instructions described herein may be allocated among the earphones 200 and the device 300 such that select computationally and/or memory intensive processes may be executed on the device 300 and retransmitted to the earphones 200 for use. As just a few examples of what may be computationally intensive, depending on how implemented, the following processes can be effected on or partially on the device 300: extraction of physiological features from physiological indicator data; determination of a cognitive state of a user 102 from physiological features; transformation of existing generative features 120 to form masking features 128 and/or generation of new masking features 128; determination of ISO state of the user 102 based on physiological features; and/or production of generative libraries 124 emulating audio tracks 152.

Although not shown, it should be noted that it is possible for the device 300 to include the generative masking engine 230, where the generative audio 126 may then be streamed to the earphones 200 for production of sound 108. Similarly, it is possible for the DSP 202 to be included within the device 300 and the output streamed to the earphones 200 for production of analog waveforms 112 on the DAC 204. This processing architecture may, however, result in continued wireless network connection between the earphones 200 and the device 300, which may continue to utilize additional battery of one or both the earphones 200 and/or the device 300.

In one or more embodiments, the device and/or base station 300B may include a physiological feature identification routine 330. The physiological feature identification routine 330 may be configured to extract one or more physiological features from physiological data of the user 102. The physiological data may describe one or more physiological indicators for a time period (e.g., an epoch). The physiological indicators may be motion, sound, temperature, and/or other sensed events indicating certain biological activity or vital signs data of the user 102. For example, a physiological indicator may include micro-motion of the user 102 indicating a heartbeat, motion of the user 102 indicating a respiration event, sound of the user 102 indicating a heartbeat (e.g., collected by listening to the sound of rushing blood within veins of the inner ear), sound of the user 102 indicating a respiration event, etc.

In one or more embodiments, the physiological feature identification routine 330 may include computer readable instructions that when executed determine one or more physiological features of the user 102 from physiological data received on one or more sensors of the earphone 200 and/or the device 300 (the physiological sensors 209 and/or the physiological sensors 309). In one or more embodiments, the physiological feature identification routine 330 may include computer readable instructions that when executed receive at a first time one or more physiological features of the user 102 from one or more sensors of the earphone 200 configured to collect physiological indicators (e.g., the physiological sensors 209, e.g., an inertial measurement unit (IMU) for detecting the rising chest of the user 102 when respiration and/or subtle periodic motions of the user 102 indicating heartbeats).

In one or more embodiments, the device 300 may include a cognitive state determination engine 332 configured to determine a cognitive state of the user 102 and/or likely cognitive state of the user 102 based on the physiological data and features derived therefrom. For example, as may be known in the art, it may be possible to infer and/or difficult to infer within a relatively high probability an awake state, a pre-sleep state (or “drowsy” state), a sleep state, a non-rapid-eye-movement sleep state (NREM state, or “shallow sleep state”), and/or a rapid-eye movement state (REM state, or “deep sleep state”). In one or more embodiments, the cognitive state determination engine 332 may include computer readable instructions that when executed determine that a cognitive state of the user 102 includes a sleep state based on the one or more physiological features. The one or more physiological features may include a heart rate of the user 102, a heart rate variability of the user 102, a respiration rate of the user 102, a respiration rate variability of the user 102, and/or a temperature of the user 102. As just one example, a sleep state can be inferred, as known in the art, by a consistent and gradual drop in respiration rate followed by a sharp but small increase in respiration rate upon the onset of sleep. In another example, passing a respiration rate variability threshold and/or heartrate variability threshold may result in a determination within a high probability that the use 102 is in an awake state. The cognitive state determination engine 332 may utilize any other techniques known in the art to reliably determine cognitive sleep state and/or awake state from physiological data of the user 102.

The device 300 may include a user profile 350 which may store data associated with the user 102. The user profile 350, for example, may store a sleep session data 352 comprising physiological and other data gathered while the user 102 was attempting to rest and/or sleep, a pre-sleep session data 354 comprising physiological data and/or other data gathered prior to sleep, and historical ISO data gathered from the user 102 and from which an ISO baseline value 356 may be determined and/or calculated. In one or more embodiments, a user session may include a pre-sleep session data 354 determined to include data gathered from initiation of the pre-sleep session until unset of the sleep state, and the sleep session data 352 may be determined to include data gathered from the onset of the sleep state to the termination of the sleep state. In one or more embodiments, the pre-sleep state data may be used to set an ISO baseline value 356 of physiological features for the user 102, which can be subsequently compared against by the ISO management engine 250 for determination of a present ISO state of the user 102. For example, where the current ISO state is determined to be above the ISO baseline value 356 (e.g., 10% above, 25% above), the user 102 may be determined to be in an “excited state”.

As further shown and described in conjunction with the embodiments of FIG. 2, the device 300 may include the track feature emulation routine 260, the track feature parse routine 262, and/or the library definition module 264, according to one or more embodiments. The device 300 may similarly store one or more instances of the generative library 124 and/or the track database 154. An instance of the generative library 124 and/or the one or more audio tracks 152 may be selected and uploaded and/or streamed to the earphones 200 in anticipation of generating certain audio for the user 102 and/or on demand.

FIG. 4 illustrates the server 400, according to one or more embodiments. Although a single instance of the server 400 is shown, it will be recognized by one skilled in the art of software engineering that the server 400 may be comprised of multiple servers. The server 400 may includer a processor 401 (which may, for example, include multiple parallel processors and/or specialized processors) and a computer memory 402 (e.g., RAM, solid state memory, hard disk memory, etc.). The server 400 may be utilized to further support the device 300 and/or the earphones 200, including with relatively computationally intensive tasks (e.g., relative to the earphones 200 and/or the device 300). In one or more embodiments, the audio track 152 may be evaluated for effective emulation through an artificial intelligence (AI) model and AI execution engine, e.g., an artificial neural network trained to recognize track features 140 and propose effective generative features 120 for emulation thereof. In one or more embodiments, a training dataset for the AI model may include supervised learning through a plurality of audio tracks 152, designation of track features 152 thereof, and designation of acceptable and/or preferred analogous generative features 120.

In one or more embodiments, the server 400 may include a master generative library 424 that may comprise one or more, or many, generative libraries 124 (e.g., a “catalog” which the user 102 can select, download, and/or utilize). Similarly, the server 400 may include a track catalog 430 that may comprise one or more, or many, audio tracks 152.

In one or more embodiments, a generative library 132 may be associated with an audio track 152, for example as a soundscape pair 164. The association may be effected through a one-way or two-way referential attribute-value pair and/or “pointer” within a database. The audio track 152 may be a high resolution version 160 of the audio track 152, whereas the generative library 120 may be a low resolution version 162. As further shown and described herein, both may be download and utilized in coordination, for example the high resolution version 160 when the user 102 is awake and/or the batteries 206 have significant charge, and the low resolution version 162 when the user 102 is determined to be asleep and/or the batteries 206 are below a certain charge threshold and/or partially depleted. In one or more embodiments, the audio track 152 may include metadata describing the arrangement and/or probabilistic arrangement of track features 150 thereof. For example, each track feature 150 of the audio track 152 that may be identified (e.g., a recurring instrument, a recurring tone, a recurring waveform) may be described with at least an audio waveform 151 and an occurrence frequency 153. The audio waveform 151 may be further described with a generative feature 120, for example a digital soundwave descriptor 132 and/or a sample 142 extracted from the audio track 152 and optionally post-processed to remove other identified and overlapping track features 150.

FIG. 5 illustrates a generative audio system 500, according to one or more embodiments. FIG. 5 illustrates the generation of both generative audio 126 and/or predefined audio 156 such as generated from an audio track 152, according to one or more embodiments. In general, the speaker 207 may produce sound 108 from an analog waveform 118. The analog waveform 118 may be sent to the speaker 207 from the DAC 204, which in turn may have received audio 116 generated by the DSP 202. The DSP 202 may have received data coding for the audio 116 from multiple sources, including a predefined source (e.g., the playback routine 272) and/or a generative source (e.g., the generative audio engine 220), each of which are now described, and as are further described throughout the present embodiments.

In one or more embodiments, the playback routine 272 may request and play an audio track 152 retrieved from the track database 154. The playback routine 272 may effect any required audio decompression that may be required by the audio format. The track database 154 may be stored on the earphones 200, stored on the device 300, and/or stored on server 400. The audio track 152 may be sent to the DSP 202 for inclusion in the audio 116. The audio track 152 may result in the predefined audio 156 as the output of the DSP 202, and then the analog waveform 112B resulting in production of the sound 108B.

In contrast, the generative audio engine 220 may request and play generative features 120 extracted from the generative library 124. The generative feature 120 may be a synthesized feature 130 (e.g., defined by one or more digital soundwave descriptors 132) and/or a sample feature 140 (e.g., defined by one or more samples 142). The generative library 124 may be stored on the earphones 200, stored on the device 300, and/or stored on server 400. In one or more preferred embodiments, however, all or a portion of the generative library 124 may be stored on the earphones 200.

The generative audio engine 220 may determine which generative features 120 to extract and forward them to the DSP 202 in various sequences, arrangements, and/or timings, and with any instructions of volume, tone, and/or other parameters that the DSP 202 is capable of adjusting on receipt. The generative features 120 then may be included in the audio 116 sent to the DAC 204. Specifically, one or more generative feature 120 may result in the generative audio 126 as the output of the DSP 202, which may then yield the analog waveform 112A resulting in production of the sound 108A. The audio 116 comprises the generative audio 126 and/or the predefined audio 156 within the capabilities of the DSP 202 and DAC 204 (e.g., channel limit of the DSP 202), including in time-varying allocations of fade or volume of each, as further shown and described in conjunction with the embodiment of FIG. 6. Although the speaker 209 is show, it will appreciated by one skilled in the art that the speaker 309 may also be utilized for generation of the sound 108A and/or the sound 108B.

FIG. 6 illustrates another generative audio system, the generative audio system 600, according to one or more embodiments. In one or more embodiments, and as shown and described through the present embodiments, predefined audio 156 may be faded to generative audio 126, and vice-versa, either manually at the request of the user and/or automatically upon occurrences of a trigger event. In the present example of FIG. 5, the user 102 may be listening to predefined audio 156, for example an audio track 152 comprising Duduk flute music. The user 102 may wish to pair the audio track 152 with generative audio, for example environmental sounds such as wind rushing through trees, water trickling over rocks, desert animals, and other sounds. In such case, the audio 116 comprises both the generative audio 126 and the predefined audio 156 until occurrence of a trigger event which results in termination of the predefined audio 156 (and possible termination of a wireless network connection on the network 101B) but possible maintenance of the generative audio 126. In another example, the predefined audio 156 may be a high-resolution version 160 of an audio track 152 which plays until a trigger event, and the generative audio 126 may be initiated after the trigger event.

In one or more embodiments, the physiological sensors 209 and/or the physiological sensors 309 may collect physiological data from which the physiological indicators may be extracted and physiological indicators determined may be extracted and physiological features 190 determined. The physiological features 190 may include, for example heart rate, heart rate variability, respiration rate, and/or respiration rate variability. A sleep state may be determined and a sleep state instruction 192 may be generated and forwarded, for example the audio source trigger module 214. The audio source trigger module 214, as previously shown and described herein, may initiate the generative audio 126 and initiate a procedure call to an audio transition routine 216 which may begin to fade the generative audio 126 into the audio 116. Simultaneously, the generative audio 126 may fade the predefined audio 156 out of the audio 116. The ear 104 of the user 102 may perceive increasing volume of the sound 108A and decreasing volume of the sound 108B. As a result, the predefined audio 156 may be replaced by the generative audio 126. Following replacement, any computationally, memory, and/or communication intensive processes related to the predefined audio 156 may be terminated and/or placed in a standby mode utilizing fewer resources. For example, the communication termination subroutine 218 may terminate a network connection with the device 300 and/or server 400, or, alternatively, enter a periodic ping or check-in mode.

In one or more embodiments, the network connection of the earphones 200 to the device 300 may be initiated from the earphones-side of earphones 200 upon occurrence of any event requiring transmission to the device 300 and/or the server 400 for further assessment. This communication pattern also potentially saves battery charge for the earphones 200. For example, certain physiological features may be able to be determined on the earphones 200 (e.g., elevated respiration rate), which may then establish a network connection with the device 300 for transmission of physiological data for more detailed determinations or calculations (e.g., assessment of respiration rate variability) over one or more epochs that may be sufficient for determining the cognitive state (e.g., whether the user has awoken).

FIG. 7 illustrates yet another generative audio system, referred to as the generative audio system 700, according to one or more embodiments. In one or more embodiments, generative audio 126 may include both generative features 120 (e.g., the generative feature 120A) and/or generative features 120 also are or may include masking features 128 (e.g., generative feature 120B). For example, in response to the environmental sound 106, a masking feature 128 may be generated, resulting in generation of a masking sound 109 to effectively mask the environmental sound 106. In one or more embodiments, and as shown in FIG. 7, the environmental sound 106 may be received on the microphone 208 and/or the microphone 308. Audio recorded by the microphone (e.g., the environmental audio data 233) may be assessed by one or more processes for identification of the environmental sound 106, for example the generative masking engine 230 and/or the environmental sound identification routine 237. A reactive mask routine 238 may then select and initiate production of the masking feature 128 within the generative audio 126, for example by generating a procedure call to the generative audio engine 220. The environmental sound 106 may have been previously identified and a masking feature 128 designated or created for use in masking the environmental sound 106. Alternatively, or in addition, the environmental sound 106 may be assessed for the first time and a response made in real time with existing generative features 120.

In one or more embodiments, the reactive mask routine 238 may query one or more generative libraries 124 for use of generative features 120 therein. In one or more embodiments, the generative feature 120B may be effective and/or efficient as a masking feature 128 for masking the environmental sound 106, as further shown and described in conjunction with FIG. 16 and throughout the present embodiments. However, in one or more other embodiments, the generative feature 120B may have been transformed to a more effective masking feature 128 for the environmental sound 106. Alternatively, or in addition, a generative feature 120B may have been newly generated to act as the masking feature 128, e.g., the new masking feature 129.

The generative feature 120A may be transmitted from the DSP 202 to the DAC 204 for production of the analog waveform 112A and the sound 108. Similarly, the generative feature 128 (whether derived from the generative feature 120B, the transformed generative feature 125, and/or the new masking feature 129) may be sent from the DSP 202 to the DAC 204, where it is converted to the analog waveform 112B for generation of the masking sound 109 on the speaker 207 and/or the speaker 307. Through this system and/or process, a generative feature 120 may be used as a masking feature 128, and/or utilized to generate a masking feature 128. The masking feature 128 may fit within (e.g., stylistically, thematically, musically, or with other similar criteria) the generative library 124 that is otherwise being utilize to provide the sound 108 to the user 102.

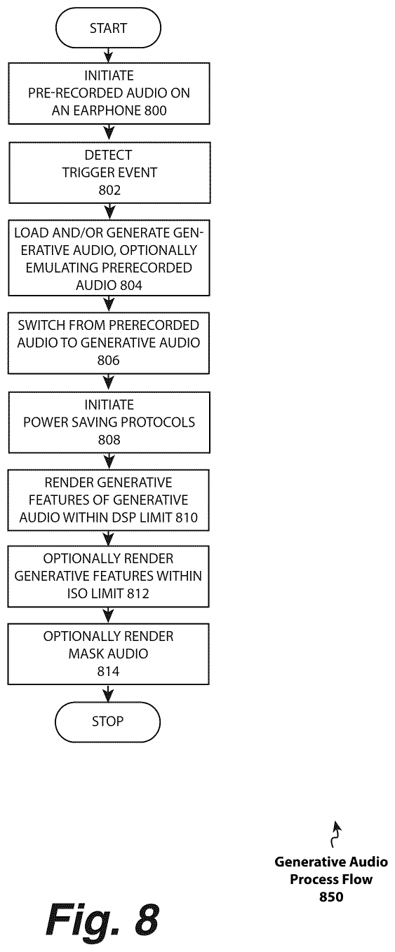

FIG. 8 illustrates a generative audio process flow 850, according to one or more embodiments. Operation 800 may initiate pre-recorded audio 156 on an earphone 200. The prerecorded audio 156 may be an audio track 152, and/or another recorded audio data or audio file. The prerecorded audio 156 may include music, vocals, sound effects, simulated sound environments, audiobook content, podcasts, voice automatically generated from text, etc. Operation 802 detects a trigger event. The trigger event may be a change in cognitive state of the user 102, a change in ISO state of the user 102, detection of a power threshold, and/or other events. Operation 804 loads and/or generates generative audio 126, optionally emulating the prerecorded audio 156. The emulation may have been constructed manually by a music engineering and/or software development team (e.g., specifying which generative features 120 approximate the prerecorded audio 156, including and without limitation compressing memory space through mathematical software code descriptions of arrangement and periodicity of certain audio waves). Operation 806 switches from the prerecorded audio 156 to the generative audio 126. The switch may occur instantly and/or abruptly, or may occur gradually, such as fading in the generative audio 126 and fading out the prerecorded audio 156. Other transitions are also possible, for example selectively rendering some but not all of the generative features 120 until the prerecorded audio 156 is below a certain fade threshold.

Operation 808 initiates one or more power saving protocols, for example for the earphones 200, the device 300, or both. In one or more embodiments, a power saving protocol includes terminating one or more network connections through the network 101, e.g., the network 101A. In one or more embodiments, a power saving protocol may include reducing processing of the processor 201 and/or processor 301, for example for sound decompression algorithms related to an audio file format such as MP3. In one or more other embodiments, a power saving protocol includes reducing volume of the sound 108 generated on the speaker 109. In one or more embodiments, a power saving protocol includes reducing computationally intensive loads on the processor 201, for example sound analysis of the environmental sounds 106, physiological feature analysis, etc.

Operation 810 may render the generative features 120 within a channel limit of a DSP 202. For the channel limit of the DSP 202 may depend on both the type of DSP 202, any I/O throughput constraints, and the type of generative features 120 or other audio to be rendered, as generally described in the specification of the DSP manufacturer's specifications and/or documentation. For example, in one or more embodiments, a generative library 124 may include a plurality of generative features 120, each of which may have an associated importance or priority value, where the generative features 120 of the highest priority within the channel limit of the DSP 202 may be rendered if a conflict would occur. The channel limit may be dynamically adjusted depending on the additional needs to channel capacity to mask and/or produce other sounds for the user 102.

Operation 812 may optionally produce generative features 120 within an ISO limit 812. The ISO limit, for example, may relate to a rate or frequency of occurrence of generative features 120, a tone of the generative features 120, a variation in one or more musical or audio properties of the generative features 120 (e.g., a maximum number of “instruments” producing sound at the same time, within the same phrase, stanza or other musical unit, and/or within relatively close succession, etc.).

Operation 814 may optionally render a mask audio. The mask audio may be a flat mask, for example a broad spectrum mask (e.g., white noise, pink noise, or brown noise), a select frequency bin but continuous mask (e.g., to remove a specific environmental sound 106), and/or a reactive masking (e.g., responsive generation of a masking feature 128 to produce a masking sound 109). In one or more embodiments, operation 814 may occur within the context and in association with operation 810 and operation 812, e.g., such that masking audio is generated within both the channel limit of the DSP 202 and any ISO limit.

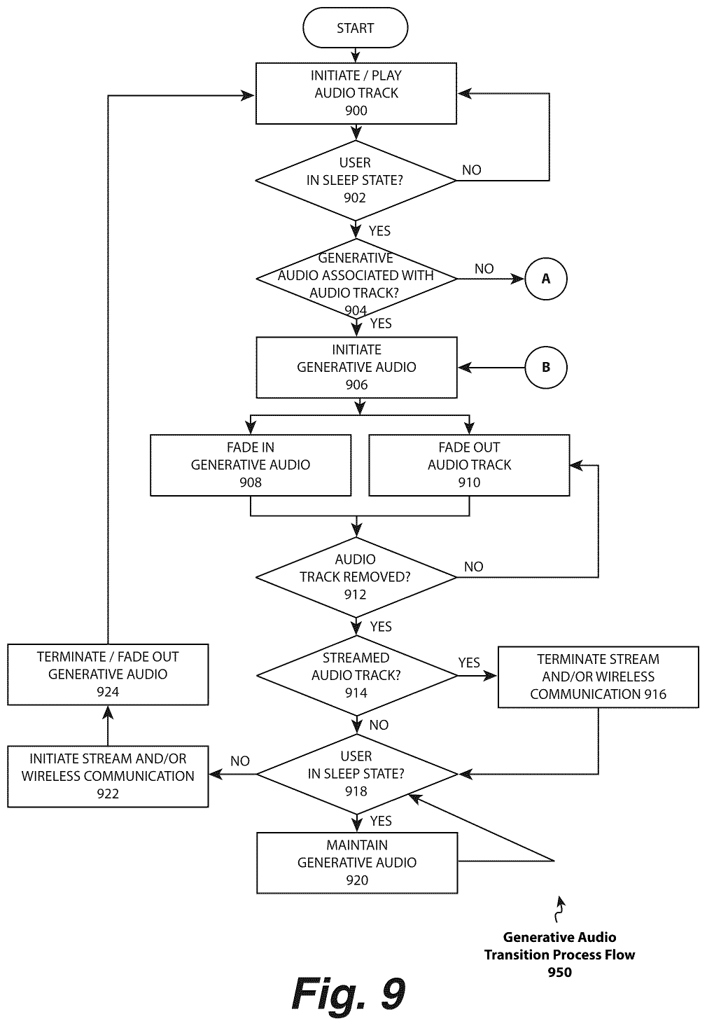

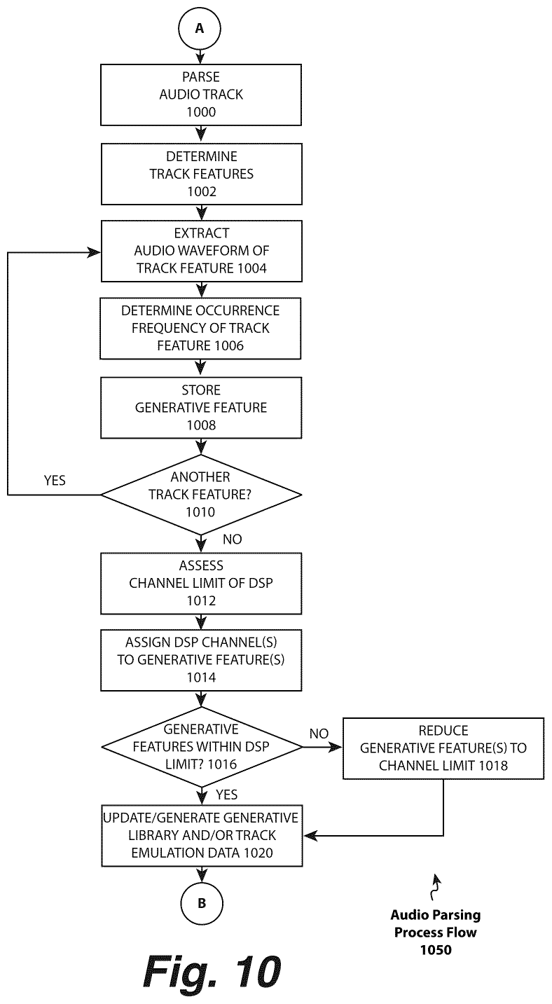

FIG. 9 illustrates a generative audio transition process flow 950, according to one or more embodiments. Operation 900 initiates an audio track 152. Operation 902 determines if the user 102 is in a sleep state. One or more techniques known in the art may be utilized to determine whether the user 102 is in a sleep state, including one or more of the systems or methods described herein. If the user 102 is not in a sleep state, operation 902 may return to operation 900, which may continue to play the audio track 152. Operation 902 may operate continuously or periodically assess the sleep state of the user 102. If the user 102 has entered the sleep state, operation 902 may proceed to operation 904, which may determine if generative audio 162 (such as one or more generative features 120) is associated with the audio track 152. The association may be implicit (similar tags, sounds, and/or “instruments” as may be described in metadata) or may be explicit. For example, an explicit association may include a database reference associating the audio track 152 and a generative feature library 124 (e.g., forming a soundscape pair 164). Where no generative audio is associated with the audio track 152, operation 904 may optionally proceed along path ‘Circle A’ to the audio parsing process flow 950 of FIG. 10.

Operation 906 may initiate the generative audio 126 determined to be associated while the audio track 152 in operation 904, and/or generative audio 126 produced from the audio parsing process flow 950 of FIG. 10. Operation 908 and operation 910 may then occur concurrently and/or sequentially. Operation 908 may fade in the generative audio 126, and operation 910 may fade out the audio track 152. Fading may be accomplished through traditional volume fading, but may also include one or more other audio processing techniques known in the art to smoothly transition one sound to another with minimal detection by the user 102 (e.g., the sound 108B to the sound 108A, as shown and described in conjunction with the embodiment of FIG. 6). Operation 912 may determine whether the audio track 912 has been removed from the audio 116. If not, operation 912 may return to operation 910. If the audio track 152 has been removed, operation 912 may proceed to operation 914.

Operation 914 determines whether the audio track 912 has been streamed. Where the audio track 152 was streamed, operation 914 may proceed to operation 916. Operation 916 may terminate a data stream (e.g., stream of audio data over a network 101) and/or wireless communications connection (e.g., through a wireless communication protocol, such as Bluetooth®, WiFi, LTE, and/or 5G). Operation 916 may then proceed to operation 918. If the audio track 152 was not streamed, operation 914 may proceed to operation 918. Operation 914 may also assess whether additional audio tracks 152 may need to be downloaded and stored locally (e.g., on the earphones 200) prior to termination of the network connection, for example the remainder of a partially-downloaded playlist within the track database 154.

Operation 918 may determine if the user 102 remains in the sleep state. If the user 102 is still in the sleep state (e.g., as may be determined from assessment of one or more physiological features, receipt of a sleep state data 190, and/or determination by other systems or methods), operation 918 may proceed to operation 920, which may maintain the generative audio 126. Operation 920 may then return and/or loop back to operation 918. Operation 918, similar to operation 902, may operate continuously and/or periodically to assess sleep state. If the user 102 is determined to no longer be in the sleep state, operation 918 may proceed to operation 922 which may initiate a stream (the data stream) and/or wireless communications from a device (e.g., the device 300, the server 400) which may stream or otherwise upload the audio track 152. Operation 924 and operation 900 to which operation 924 returns may then reverse operation 906, operation 908, and operation 910, for example fading in the audio track 152 and fading out the generative audio 126. Alternatively, or in addition, operation 924 may try to replace the generative audio 126 with the audio track 152 as quickly as possible upon a determination that the user 102 is in the awake state, such that the user 102 only instantaneously experiences or barely recognizes the generative audio 126 which may, according to one or more embodiments, include a low resolution version 162 compared with the audio track 152. The generative audio process flow 950 may terminate at any point at which the user 102 indicates that an audio session and/or sleep session is to terminate, for example, the user 102 taking the earphone 200 out of the ear 104 (as may be determined from the physiological sensors 209), placing the earphones 200 in a charging dock, and/or substantial movement (as may be determined from an IMU) indicating the user 102 is sitting up in bed after lying down and/or up and walking.

FIG. 10 illustrates an audio parsing process flow 1050, according to one or more embodiments. The audio parsing process flow 1050 may be initiated in isolation (e.g., to prepare soundscape pairs 164 ahead of download and use), and/or may be initiated as part of an on-demand need for the parsing, for example proceeding from the process flow of FIG. 8. Operation 1000 may parse an audio track 152 into two or more constituent parts, for example individual prominent and/or recuring audio and/or musical features. Operation 1002 may then determine one or more track features 150 that may be designated, selected, and/or stored. Operation 1004 may extract an audio waveform of the track feature 1004, for example a complex waveform including one or more waves each having a frequency and amplitude (which may vary in the time domain over the course of the feature). Operation 1006 may then determine an occurrence frequency of the track feature 102, for example an occurrence in a periodical pattern (a beat), a probabilistic occurrence (e.g., especially where no periodic pattern can be detected), and/or a relative occurrences to one or more other track features 150. Operation 1008 may then store a generative feature 120 that emulates and/or acts as an analog for the track feature 152. The generative feature 120 may be stored in a generative feature library 124, and the waveform may be directly described in terms of all or primary constituent waves stored as one or more soundwave descriptors 132. For example, in one or more embodiments, the track feature 150 may be described by its occurrence frequency of occurrence within the audio track 152, a probability of occurrence within the audio track 152, a complex audio waveform comprised of one or more waves having frequencies and amplitudes, data specifying a frequency bin, fixed or probabilistic relationships to other track features 150, and/or other audio descriptors. Alternatively, or in addition, operation 1004 may extract a sample 142 that may include a sample feature 140 emulating and/or approximating the track feature 150, according to one or more embodiments. Operation 1010 determines whether an additional track feature 150 is present in the initial parse, in which case operation 1010 may return to operation 1004. If all track features 150 have been accounted for, operation 1010 may proceed to operation 1012. In accounting for track features 150, operation 1010 may set a cutoff to determine the most prominent features, and/or utilize an arbitrary number (the top ten track features 150), where prominence may be determined through occurrences frequency, tone, amplitude, and relative occurrence around or isolation from other track features 150. Following completion of operation 1010, there may be a relatively complete (if not partially intentionally attenuated) number of generative features 120 usable to emulate the audio track 152 and features thereof. Data for the particular arrangement of audio features to exactly emulate the audio track 152 (e.g., the timing and/or volume of each generative features 120) may be stored in a separate track emulation data 158, as further described below. For example, following multiple loops of operation 1002 through operation 1010, there may be determined to be twenty generative features 120 (e.g., a newly created instance of the generative library 124) emulating twenty track features 150, where each generative feature 120 may occur multiple times, and where each occurrence may be described by the occurrence frequency. The occurrence frequency may be stored in a track emulation data 158 that may be associated with the set of generative features 120 and/or the newly created generative library 124.

Operation 1012 may determine a channel limit of a DSP 202, for example a DSP 202 on which the generative features 120 are likely to be rendered. For example, the channel limit for the DSP 202 may be between four and twelve, depending on the processor 203 and/or the processor 303, or another type of processor on another type of device on which the generative feature 120 is to be rendered. Operation 1014 may assign one or more DSP channels to generation of the generative features 120. One or more channels may also be reserved for passive or active masking audio rendering of alarms the user 102 may have set, notification of incoming calls, and/or direct use by the operating system of the device 300. Operation 1016 may then determine if the generative features 120 are within the available channel limit of the DSP 202. If not, operation 1016 may proceed to operation 1018, which may reduce the generative features 120 to be rendered to be within the channel limit of the DSP 202. It should be noted that the channel limit may be a static and/or “hard” limit allocation (e.g., 4 of 8 channels), or may be dynamic based on other current needs and uses of the DSP 202 (all 8 channels, unless and until another audio rendering needs arise, in which case the number of allocated channels to the generative audio 126 may be reduced temporarily). In one or more embodiments, the determination of operation 1016 may be made according to each occurrence within the track emulation data 158. For example, there may only be six channels available for rendering at any given time, in which case any temporal occurrence or overlap may cause reduction of the generative features 120 to six channels, and where a priority of inhibited generative features 120 may be called out within the track emulation data 158. Operation 1020 may then update and/or generate the generative library 124, including the track emulation data 158 updated for assessment of the channel limit of the DSP 202. Operation 1020 may then proceed to terminate, and/or may return along path ‘Circle B’ to the process flow of FIG. 8. In one or more embodiments, the track emulation data 158 may be additionally stored without assessment of the channel limit of the DSP 202, where the channel limit of the DSP 202 may be allocated in real time and generative features 120 may be “clipped” and/or may be selectively unrendered, based on random selection and/or man assigned priority or prominence.

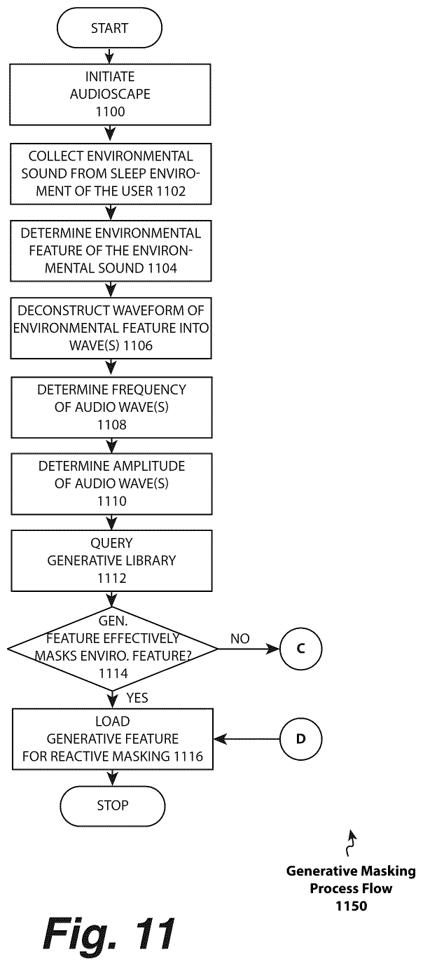

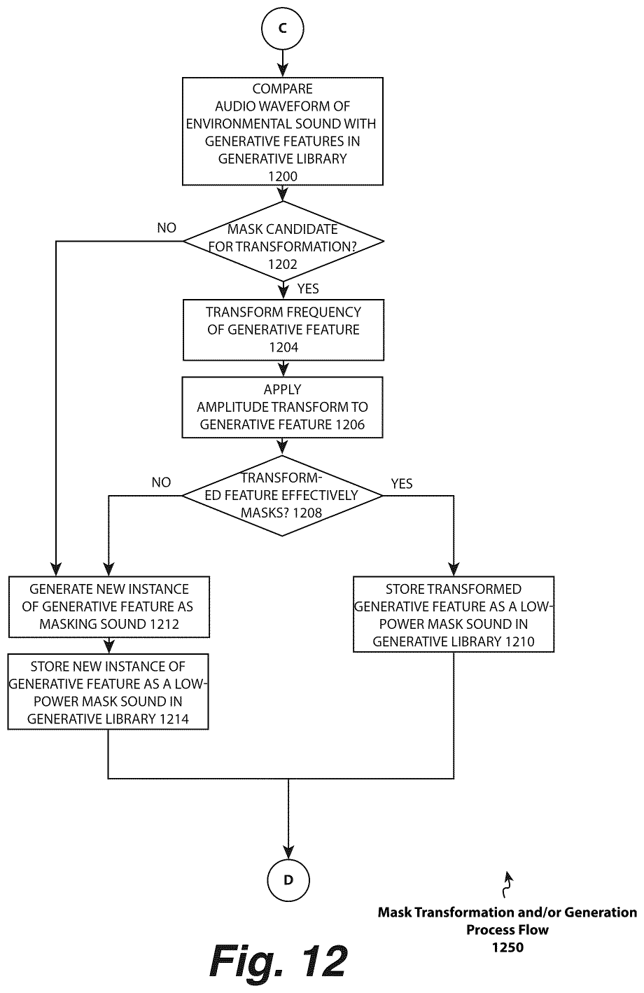

FIG. 11 illustrates a generative masking process flow 1150, according to one or more embodiments. Operation 1100 may initiate an audioscape 118, for example sound effects alone or in combination with music and/or vocals. The audioscape 118 may be comprised of predefined audio 156 and/or generative audio 126. Operation 1102 may collect an environmental sound 106 from an environment of the user 102. For example, the environmental sound 106 may include many noises, recurring sounds, and/or a collection of recurring sounds within a set of one or more frequency bins, etc. Operation 1104 may determine an environmental feature of the environmental sound. For example, feature extraction techniques similar to music and/or audio track 152 parsing may be utilized. Operation 1104 may then deconstruct the environmental feature, for example deconstructing a complex waveform with a Fourier transform or FFT, and/or separation into more granular frequency bins. Operation 1110 may determine an amplitude of the audio waves, and operation 1112 may determine the frequency (e.g., tone) of each of the audio waves. Operation 112 may then query one or more generative libraries 124 to extract one or more generative features 120 for comparison to the environmental feature. Operation 1114 may determine whether at least one generative feature 120 of the one or more generative libraries 124 that effectively masks the environmental feature, as known in the art of audio engineering. Alternatively, or in addition, an example of the determination of masking is also further shown and described in conjunction with the embodiment of FIG. 16, and in other embodiments herein. If a generative feature 120 that is or includes an effective masking feature 128 cannot be determined, operation 1114 may proceed along path ‘circle C’ to the process flow of FIG. 12. However, if an effective generative feature 120 is identified for use as a masking feature 128, the generative feature 120 may be loaded and/or readied (in quick access and/or RAM memory 203) for reactive masking of the environmental sound 106 and/or the environmental feature within the environmental sound 106. Operation 1116 may then terminate.

In one or more embodiments, operation 1114 may execute on a supporting device such as the device 300. In one or more other instances, the operation 1114 may be constrained as to which generative libraries 124 may be assessed, for example, only the generative library 124 for the soundscape 1118 initiated in operation 1100. It will be noted that in one or more embodiments, complete deconstruction of the waveform of the environmental feature may not be necessary; for example, assessment of frequency bin may be sufficient for testing and determining an efficient masking feature 128 for the environmental sound 106. In one or more embodiments, generative features 120 may be indexed within the generative library 120 for rapid query such that an attempt can be made to mask new environmental sounds 106 and/or environmental features in realtime based on preliminary attributes such as frequency bin and/or volume alone. The index may organize the generative features 120 such that a query for frequency bin masking potential may be made against the generative library 124.

FIG. 12 illustrates a mask transformation and/or generation process flow 1250, according to one or more embodiments. The process flow 1250 may initiate at operation 1200, and/or may proceed from the process flow 1150 of FIG. 11. Operation 1200 may compare an audio waveform of an environmental sound 106 (e.g., an audio waveform extracted from an environmental feature of the environmental sound 106) with one or more generative features 120 within the generative library 124. For example, one or more sinewaves including frequency and amplitude and/or frequency bins and associated volumes may be compared for both the environmental feature and one or more generative features 120. Operation 1202 may determine whether one or more of the generative features 120 may be a transform mask candidate. For example, a candidate generative feature 120 may be one that, with only minor modification (e.g., a 2%, 5%, 10%, 25%, etc. shift in frequency, frequency bin, volume, playback duration, and/or other audio attributes) may effectively mask the environmental sound 106 and/or environmental feature therein. For example, a best candidate generative feature 120 may have the least distance between the most prominent sinewave peaks and/or frequency bins when compared with the environmental feature. In another example, the best candidate may have the least required percentage change of the combination of both the frequency (tone) and amplitude (volume). If no generative features 120 are present within the generative library 124 that are candidates for effective masking, operation 1202 may proceed to operation 1212. However, where an effective mask candidate for further transformation is determined to be present within the generative library 124, operation 1202 may proceed to operation 1204. Operation 1204 may transform a frequency of the generative feature 120 (e.g., one or more sinewave frequencies and/or a frequency bin) of the generative feature 120. For example, the frequency may be shifted higher or lower depending on a desired masking tone and volume requirements of the environmental sound, as also further shown and described in conjunction with the embodiment of FIG. 16. In one or more embodiments, a calculation as to the required frequency shift may be completed by applying a masking approximation function which may fit exponential or other curves through a peak point and/or prominent point of the audiowave of the generative feature 120, determining a relative location of a peak point and/or prominent point of the environmental feature, and calculating a transform that will move the peak point and/or the prominent point of the audiowave of the generative feature 120 until the environmental feature is under the curve of the approximate masking function projected by the transformed instance of the generative feature 120 (e.g., the transformed generative feature 125). The approximate delay of the reactive masking may be taken into account (e.g., typically in tens of milliseconds) when modeling the relative positions of the anticipated peak points and/or prominent points of the environmental features and the candidate generative feature 120.

Operation 1206 may similarly apply an amplitude transform to the generative feature 120 (e.g., generally amplification of the waveform, although in some cases a volume decrease possibly in combination with a frequency shift). As just one example, an approximation of the relative volume increase of the frequency bin of the generative feature 120 may be made relative to the frequency bin of the environmental feature to ensure the environmental feature ends up under the masking curve approximating the masking capability of sound. It should be noted that although operation 1204 and operation 1206 are shown sequentially, the order may be reversed. Similarly, cither alone typically may be sufficient to transform a generative feature 120, but complex rules may prefer one over the other, or a combination thereof. For example, it may be preferrable, according to a priority, to apply a frequency transform up to 5%, but if not possible, then an amplitude transform up to 10%, and if effective masking is still not possible, under these constraints then a frequency transform of up to 3% along with an amplitude transform up to 8%. In one or more embodiment, therefore, transformation of a generative feature 120 into a transformed generative feature 125 that is also a masking feature 128 may occur using partially a volume and/or amplitude shift and partially a tone and/or frequency shift. In one or more embodiments, it will be recognized that an environmental feature initially characterized may later be experienced at various volumes (a dog barking louder or closer than when initially characterized). In one or more embodiments, frequency shifting may be reserved for an initial determination of the masking feature 128, while changes in volume of that masking feature 128 may be effected in real time to respond to the various volume of the environmental feature.

Operation 1208 may test whether the transformed generative feature 125 effectively masks the environmental feature. In a straightforward example, it may be simply determined whether the transformed generative feature 125 is sufficiently under the masking curve within the constraint rules of allowed transformation (e.g., maximum percentage transformations). If no effective mask feature 128 can be produced, operation 1208 may proceed to operation 1212. If the transformed generative feature 125 is anticipated to be an effective masking feature 128, operation 1208 may proceed to operation 1210, which may store the transformed generative feature 125. The transformed generative feature 125 may be stored as a mask feature 128 that may effectively act to generate a low-powered mask sound (e.g., the masking sound 109). Operation 1208 may store the transformed generative feature 125 within the generative library 124 from which the generative feature 120 that was transformed may have been originally extracted. The transformed generative feature 125 may be permanently stored for the user 102, or may be temporarily stored (e.g., deleted upon an event such as the user 102 changing environments, deleted upon ending of a sleep session, etc.). Operation 1210 may then terminate, or may return along path ‘circle D’ to FIG. 11.

Operation 1212 may generate a new instance of a generative feature 120 as a masking sound 109 (e.g., a new masking feature 129). For example, a waveform having the ideal frequency and amplitude may be constructed. Additional rules may be employed to attempt to keep the new masking feature 129 within stylistic, artistic, and/or thematic boundaries of the generative library 124. For example, the new masking feature 129 may have to be defined within certain frequency bin and/or volume requirements relative to other generative features 120 within the generative library 124. operation 1212 may proceed to operation 1210, which may store the new instance of the generative feature 120 that is the new masking feature 129. The new masking feature 129 also may be stored as a mask feature 128 that may effectively act to generate a low-powered mask sound (e.g., the masking sound 109). Operation 1214, similar to operation 1208, may store the new masking feature 129 within the generative library 124 in which the generative feature 120 was originally assessed for transformation, and/or in a different generative library 124. The new masking feature 129 may be permanently stored for the user 102, or may be temporarily stored (e.g., deleted upon an event such as the user 102 changing environments, deleted upon ending of a sleep session, etc.). Operation 1214 may then terminate, or may return along path ‘circle D’ to FIG. 11.

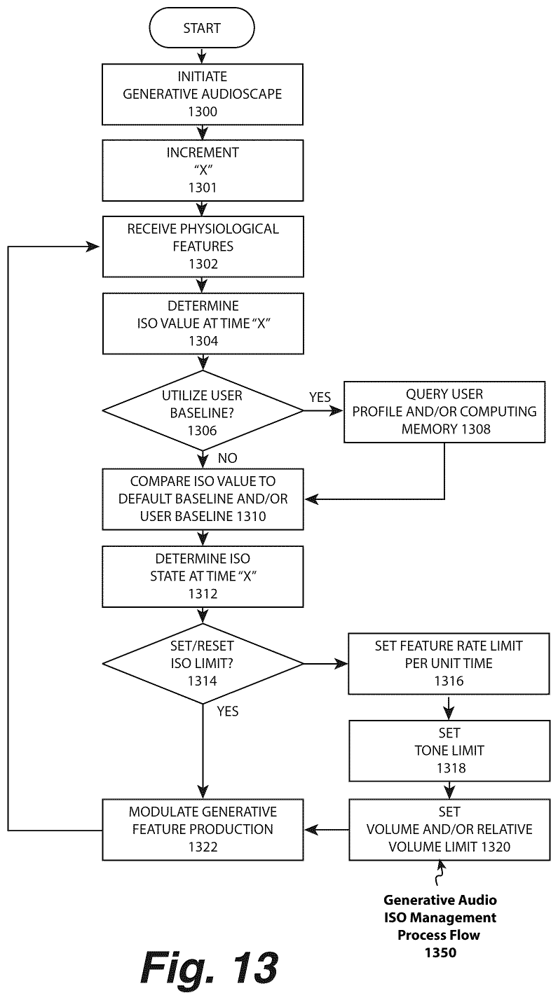

FIG. 13 illustrates a generative audio ISO management process flow 1350, according to one or more embodiments. Operation 1300 may generate an audioscape 118. For example, the audioscape 118 may be composed of varying sounds that may be thematically and/or otherwise associated, e.g., “distant busy city sounds”, or “prairie”. Other audioscapes 118 may include vocals and/or music. The elements of the audioscape may be composed and arranged from generative features 120, either according to a pattern, a schema, randomly, and/or probabilistically. Operation 1301 may increment a variable describing a first time, denoted ‘x’. For example, the first time and/or loop of the process flow 1350, x may be set equal to one.

Operation 1302 may receive physiological features for assessment, for example from and/or derived from data sensed by one or more physiological sensors 209 and/or physiological sensors 309. The physiological features may include, for example, heart rate, heart rate variability, respiration rate, respiration rate variability, user temperature, user motion, and/or other features suitable for determining ISO state and/or emotional state of the user 102 as known in the art. Operation 1304 may determine an ISO value at time ‘x’. The ISO value may be assigned according to an arbitrarily defined scale, with one or more physiological features each contributing toward the ISO value, for instance each factor added together and each multiplied by a factor acting as a weighting coefficient. More complex conditions and functions utilizing the ISO value also may be utilized. For example, in one or more embodiments, an ISO state recognition model utilizing supervised and/or unsupervised machine learning may be deployed, where the user 102 may provide feedback as to their mental or emotional state to train or fine-tune an artificial neural network trained generally on ISO state date gathered from a plurality of other users 102.

Operation 1306 may determine if a user baseline should be checked (e.g., the ISO baseline value 356). Operation 1308 may query a user profile 350 and/or another location in the computing memory 203 and/or the computing memory 303 to determine if a user baseline is available, and if available read the user baseline for use. Operation 1310 compares the ISO value to the user baseline and/or to a default baseline (if a user baseline is not to be utilized or is unavailable). Operation 1312 determines the ISO state at the first time, e.g., x equal to one. In one or more embodiments, the ISO state may be determined by calculating a difference and/or a variance between the ISO value and the baseline (either default and/or user baseline). For example, the ISO state may be or include a determination of the user 102 being “calm,” “excited,” or “normal”. More gradations are possible, including a numerical value (e.g., score range) assigned to each to represent state.

Operation 1314 determines if a new ISO limit for generative audio 126 should be set or reset, and for example the new ISO limit should be specifically applied to the audioscape 118. The determination may depend on whether the process flow 1350 has looped one or more times between operation 1322 and operation 1301. For example, if it is an objective of the user 102 to maintain the ISO state, operation 1314 may, in the first iteration, proceed to operation 1316, to set initial ISO limits, but in subsequent iterations or loops between operation 1322 and operation 1301 proceed to 1322 if the ISO state of the user 102 continues to be maintained as determined by operation 1312. In contrast, where it may be an objective of the user 102 to change ISO states, operation 1314 may proceed to operation 1316 to begin adjusting variables (changing ISO limits) that impact the generative features 120 within the audioscape 118.

The objective of the user 102 may be explicit and manually defined, or may be implicit in a selection the user 102 may make for the audioscape 118 (e.g., an objective of achieving a calm state when the user 102 selects a “guided meditation”). In one or more embodiments, the objective of the user 102 may be implied. For example, if the user 102 is attempting to rest or sleep, it may be an known objective of the user 102 to achieve a calm ISO state. The converse may be true of the user 102 attempting to begin an exercise routine and/or workout.

In one or more embodiments, custom data and/or a profile may be developed for each user 102 based on data collected from the user 102 (e.g., data collected from the physiological sensors 209, the physiological sensors 309, and/or an input user interface such as the display 304 of the device 300). For example, the user 102 may be promoted within a graphical user interface (GUI), “asked” through a voice interface, or otherwise directed to provide feedback as to how calm or excited the user 102 to set a user baseline (e.g., the ISO baseline value 356) and/or assign states for that user 102 (e.g., very excited, excited, normal, calm, very calm) relative to the user baseline.

Operation 1316 may set a feature rate limit per unit time. For example, the feature rate limit may prevent rendering of more than three generative features 120 within five seconds and/or no more than two in any one second. Alternatively, or in addition, the diversity of generative features 120 may be set to a threshold. For example, where an audioscape 118 is or includes a nature audioscape, the number of animal sounds may be limited. Similarly, where the audioscape 118 is a muffled orchestra tuning their instruments, the number of instruments available to be rendered within a generative library 124 may be reduced. Operation 1318 may set a tone limit. For example, generative features 120 with audiowave frequencies, dominant audiowave frequencies, and/or frequency bins above (or below) a threshold may be inhibited or otherwise prevented from being rendered (e.g., on a DSP 202). In one or more embodiments, exceptions may apply to masking features 128, unless maintaining ISO state is determined, or set to be, of higher priority. In such case, the generative feature 120 that would be the masking feature 128 may be inhibited or otherwise prevented from reactive masking, and/or an “inept” or only partially effective masking feature 128 that is within the tone limit may be utilized to partially mask the environmental sound 106. For example, the environmental sound 106 or environmental feature thereof may still protrude above the effective masking threshold 1604. Operation 1320 may similarly set a volume and/or relative volume limit for generative features 120. For example, the volume threshold of each generative feature 120 may be reduced, and/or the relative volume of each generative feature 120 relative to each other generative feature 120. In one or more embodiments, the environmental sound 106 and any intended masking thereof may be automatically assessed before reducing the volume limit. Operation 1322 may modulate the generative feature 120 production within the audioscape 118, for example preventing rendering that would violate limits set by operation 1316, operation 1318, and/or operation 1320. Operation 1322 may then return to operation 1302, which may increment ‘x’ to evaluate a second time. Evaluations and/or loops may occur continuously or in periods, e.g., every few seconds, each 90 seconds, every few minutes, etc.

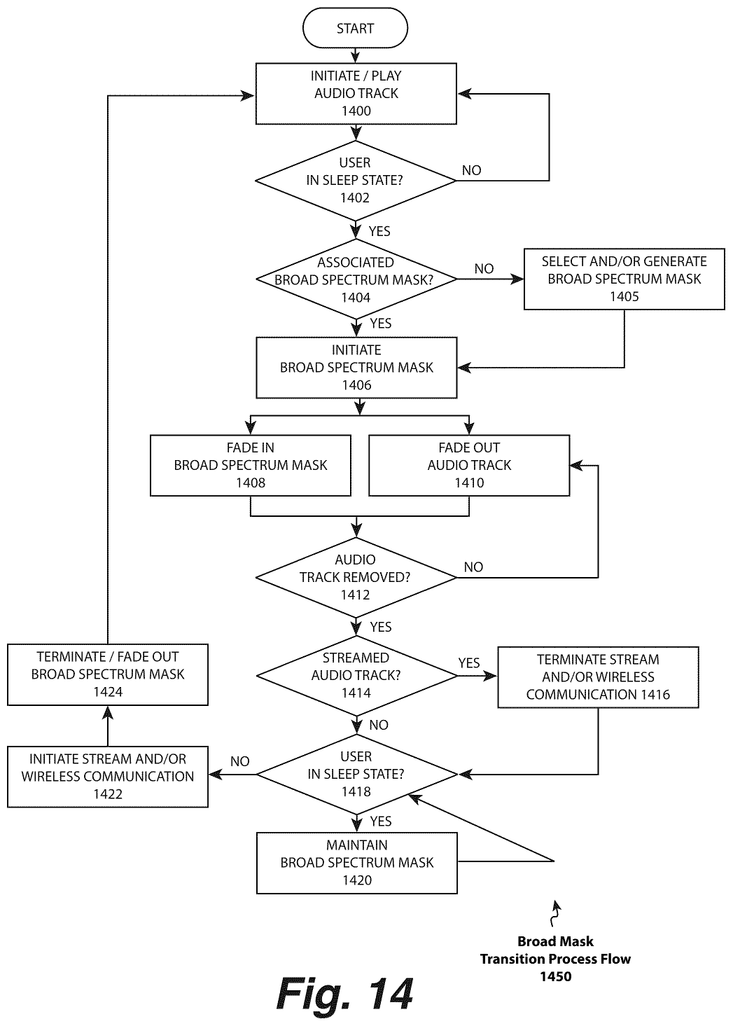

FIG. 14 illustrates a broad mask transition process flow 1450, according to one or more embodiments. Operation 1400 initiates an audio track 152. Operation 1402 determines if the user 102 is in a sleep state. If the user 102 is not in a sleep state, operation 1402 may return to operation 1400, which may continue to play the audio track 152. Operation 1402 may operate continuously or periodically to assess the sleep state of the user 102. If the user 102 has entered the sleep state, operation 1402 may proceed to operation 1404, which may determine if a broad spectrum mask is associated with the audio track 152. For example, certain generative libraries 124 and/or audioscapes 118 may have one or more associated broad spectrum masks for use therewith. Where no broad spectrum mask is associated with the audio track 152, operation 1404 may optionally proceed to operation 1405 which may select a broad spectrum mask from one or more available options and/or generate a broad spectrum mask. The broad spectrum mask may be a white noise, a pink noise, and/or a brown noise, as known in the art of audio engineering. In one or more embodiments, a multi-spectrum mask may also be automatically generated covering many of most of the frequencies which have been detected within the environmental sound 106 and/or environmental features thereof.

Operation 1406 may initiate the broad spectrum mask. Operation 1408 and operation 1410 may then occur concurrently and/or sequentially. Operation 1408 may fade the audio track 152 out (and/or any other the generative audio 126 being played with the audio track 152). Operation 1410 may fade in the broad spectrum mask. Fading may be accomplished through traditional volume fading. However, alternatively or in addition, one or more other audio processing techniques known in the art to smoothly transition one sound to another may be utilized (e.g., the sound 108B to the sound 108A, as shown and described in conjunction with the embodiment of FIG. 6). Operation 1412 may determine whether the audio track 152 has been removed from the audio 116. If not, operation 1412 may return to operation 1410. If the audio track 152 has been removed, operation 1412 may proceed to operation 1414.

Operation 1414 determines whether the audio track 1412 has been streamed. Where the audio track 152 was streamed, operation 1414 may proceed to operation 1416. Operation 1416 may terminate a data stream (e.g., stream of audio data over a network 101) and/or wireless communications (e.g., on a wireless communication protocol, such as Bluetooth®, WiFi, LTE, and/or 5G). Operation 1416 may then proceed to operation 1418. If the audio track 152 was not streamed, operation 1414 may proceed to operation 1418. Operation 1414 may also assess whether additional audio tracks 152 may need to be downloaded and/or stored locally prior to termination of the network connection, for example the remainder of a playlist within the track database 154.

Operation 1418 may determine if the user 102 is still in the sleep state. If the user 102 is still in the sleep state (e.g., as may be determined from assessment of one or more physiological features, receipt of a sleep state data 190, and/or determination by other systems or methods), operation 1418 may proceed to operation 1420, which may maintain the broad spectrum mask. Operation 1420 may then return and/or loop back to operation 1418. Operation 1418, similar to operation 1402, may operate continuously and/or periodically to assess sleep state. If the user 102 is determined to no longer be in the sleep state, operation 918 may proceed to operation 1422 which may initiate a stream (the data stream) and/or wireless communications from a device (e.g., the device 300, the server 400) which may stream or otherwise upload the audio track 152. Operation 1424 and operation 1400 to which operation 1424 returns may then reverse operation 1406, operation 1408, and operation 1410, for example fading in the audio track 152 and fading out the broad spectrum mask. Alternatively, or in addition, operation 1424 may try to replace the generative audio 126 with the audio track 152 as quickly as possible (e.g., hundredths of a second, one second, a few seconds) upon a determination that the user 102 is in the awake state, such that the user 102 only instantaneously or barely recognize the broad spectrum mask. The generative audio process flow 1450 may terminate at any point at which the user 102 indicates that an audio session or sleep session is to terminate, for example taking the earphone 200 out of the ear 104 (as may be determined from the physiological sensors 209), placing the earphones 200 in a charging dock, and/or detecting substantial movement indicating the user 102 is sitting up in bed after laying down and/or up and walking, as may be determined from the IMU which may include an accelerometer.

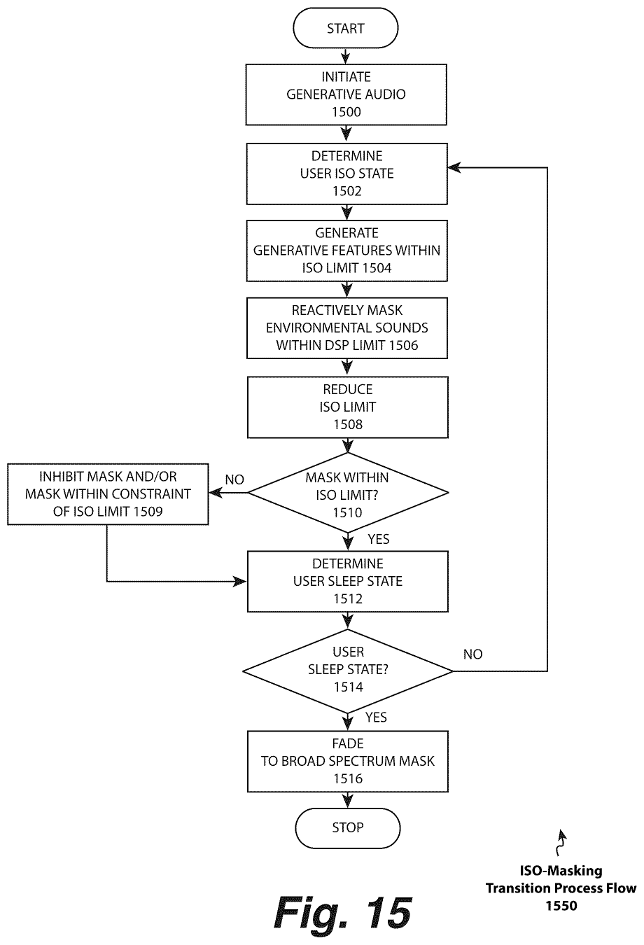

FIG. 15 is an ISO masking transition process 1550, according to one or more embodiments. Operation 1500 may initiate generative audio 126, for example synthesized audio 136 and/or composed sample audio 146. Operation 1502 determines an ISO state of the user 102, for example an objective measure and/or value associated with one or more physiological conditions from which data can be derived, for example heart rate, resting heart rate when the user 102 has not substantially moved for a period of time and/or is lying flat or sitting (e.g., as may be determined from an IMU), blood pressure, temperature relative to ambient tempreture (e.g., environmental temperature), etc. Operation 1504 may generate generative features 120 within an ISO limit, for example an ISO rate limit related to the number of generative features 120 that can be rendered within a unit time period, the variety of generative features 120 allowed to be rendered (e.g., the number of “instruments” or “sound effects” within an audioscape 118), the tone of generative features 120, and/or the volume or relative volume of generative features 120.

Operation 1506 initiates reactive masking of an environmental sound 106, for example as further shown and described in conjunction with FIG. 2, FIG. 7, and throughout the present embodiments. For example, a masking feature 128 may be queried and prepared for use (e.g., loaded in memory 203 or otherwise prepared for immediate use). Operation 1508 may then determine if rendering of the masking feature 128 would occur within the ISO limit, and if so proceeds to operation 1510. If rendering of the masking feature 128 is not within the ISO limit, operation 1508 may proceed to operation 1509 which may either stop the reaction to the environmental sound 106, and/or may make a limited reaction within the ISO limit (e.g., a reduced volume that may only partially act as an effective mask to the environmental sound 106 or environmental features thereof but which may be within the ISO limit). Alternatively, or in addition, a faster determination as to whether to reactively mask may be made if the determination occurs prior to the evaluation of the masking feature 128 to be deployed. For example, where too many generative features 120 have been rendered within an epoch, any reactive masking may be blocked if sound generation would violate the ISO rate limit on the number of generative features 120 to be rendered per unit time.

Operation 1510 may reduce an ISO limit (e.g., the ISO rate limit), e.g., as shown and described in conjunction with the embodiment of FIG. 13, for example to assist in lowing the ISO state of the user 102. Operation 1512 may determine the sleep state of the user 102. In one or more embodiments, a sleep state may be inferred from prolonged calm ISO state, and/or may be made as a separate determination from the same or similar physiological features. Where the user 102 is in the sleep state, operation 1514 may proceed to operation 1516. If the user 102 is not in the sleep state, operation 1514 may return to operation 1500 which may maintain the generative audio 126 within the ISO limits and/or reduced ISO limits of operation 1510. Operation 1514 through operation 1500 may continue to loop until the ISO state is significantly reduced leading to the sleep state. Where the user 102 has achieved the sleep state, operation 1516 may fade to a broad spectrum mask, for example fading out the generative audio 126 and fading in the broad spectrum mask. In one or more embodiments, if the user 102 wakes, the process may be reversed, fading out the broad spectrum mask and fading in the generative audio 126, including any reactive masking.

FIG. 16 illustrates an example generative feature masking and transformation graph 1600, according to one or more embodiments. The x-axis of the graph shows tone and/or sound frequency in Hz, with division approximately logarithmically arranged for clarity of presentation with respect to the hearing capability of the human ear. The y-axis shows sound level, e.g., volume and/or amplitude, measured in decibels. The broken line indicates a typical hearing threshold 1602 of the human ear, although the hearing threshold 1602 may vary by age, gender, and/or other factors.

FIG. 16 illustrates several instances of: (i) generative features 120 (e.g., the generative feature 120A centered approximately at 250 Hz, a generative feature 120B center approximately at 300 Hz, and a generative feature 120C centered approximately at 600 Hz); (ii) environmental sounds 106 (e.g., an environmental sound 106A centered at approximately 180 Hz, an environmental sound 106B centered at approximately 800 Hz); and (iii) transformed generative features 125 (the transformed generative feature 125A centered approximately at 600 Hz, and the transformed generative feature 125B centered approximately at 650 Hz). The dotted line shows an approximation of the effective masking 1604 of the generative feature 120A, and also the generative feature 120C following transformation to either the transformed generative features 125A or the transformed generative feature 125B.

The environmental sound 106A, for example, may be an environmental feature that may be unwanted noise (e.g., a dog bark) which will be heard by the user 102 because its sound level rises above (“breaches”) the hearing threshold 1602 at the given frequency (approximately 180 Hz). The environmental sound 106A may be masked by a masking feature 128 that is generated within a sufficient time either before or after the environmental sound 106A, as known in the art. For example, the environmental sound 106A would also be masked by the generative feature 120 if the environmental sound 106A was centered at approximately 300 Hz, provided it was generated within a sufficient amount of time before or after the environmental sound 106A.

In the present embodiment, the effective masking threshold 1604 assumes that the environmental sound 106 and the generative feature 120 effectively masking the environmental sound 106 are effectively timed, e.g., that they occur simultaneous or within pre-masking or post-masking effect periods. In one or more embodiments, the sufficient time for generating the generative feature 120 and/or the transformed generative feature 125 that will act as the masking feature 128 may be measured in milliseconds (e.g., a “pre-masking” within 20 milliseconds of the onset of the environmental sound 106). In one or more embodiments, effective masking may occur both before and after a masking sound 109 is heard by the ear 104 and/or processed by the brain of the user 102 (e.g., through the primary auditory cortex of the brain) as long as such masking sound 109 is heard within a decay time period. For example, a third axis (e.g., a z-axis), not shown but which could be added to the present embodiment, may express elapse time from environmental sound 106 to generation of the masking feature 128. Effective masking may then occur under a function outputting a surface in three dimensions as a function of independent variables which include: a variable of frequency, a sound level, and elapse time before and/or after the environmental sound 106. In one or more embodiments, the generative feature 120 acting as the masking feature 128 can also be maintained throughout detection of the environmental sound 106 (e.g., played for a prolonged period within the audio 116), especially for generative features 120 that form a logically consistent continuous sound (e.g., a buzzing cicada, crickets chirping, simulated wind). Post-masking of the environmental sound 106 may occur up to 200 milliseconds after the masking feature 128 ends.

FIG. 16 further illustrates transformation of a generative feature 120C to effectively mask the environmental sound 106B. Prior to transformation, the generative feature 120 may not effectively mask the environmental sound 106B, e.g., the effective masking threshold 1604 of the generative feature 120 will not completely “cover” and/or stay above the environmental sound 106B. Therefore, the generative feature 120 may be subject to a transform of either frequency and/or volume. A sound level increase from approximately 50 dB to 62 dB may raise the effective masking threshold 1604 until the environmental sound 106 is underneath the effective masking threshold 1604 (e.g., therefore defining the transformed generative feature 125A). Alternatively, the frequency may by increased (e.g., the center of the generative feature 120C moved from 600 Hz to 650 Hz), which may also raise the effective masking threshold 1604 near to the environmental sound 106 until the environmental sound 106 is underneath the effective masking threshold 1604 (e.g., therefore defining the transformed generative feature 125B). As further shown and described herein, the transformed generative features 125 may be stored for later use in a generative library 124, cither permanently or temporarily, and/or may be stored in rapid access memory for reactive masking.

It should be noted that in one or more embodiments, the trigger even may transition between generative features 120, rather than generative audio 126 versus predefined audio 156. For example, the generative features 120 may include daytime sounds (passeriform songbirds, large mammals) that as the user 102 gets sleepier (e.g., a pre-sleep state is detected) turns to evening sounds (bats, certain game birds that call at dusk, Common Nighthawks, etc.), and finally when the user 102 falls asleep, to nighttime sounds (e.g., owls, coyotes or wolves, wind).

Although the present embodiments have been described with reference to specific example embodiments, it will be evident that various modifications and changes may be made to these embodiments without departing from the broader spirit and scope of the various embodiments. For example, the various devices, engines, agent, routines, and modules described herein may be enabled and operated using hardware circuitry (e.g., CMOS based logic circuitry), firmware, software, or any combination of hardware, firmware, and software (e.g., embodied in a non-transitory machine-readable medium). For example, the various electrical structure and methods may be embodied using transistors, logic gates, and electrical circuits (e.g., application specific integrated circuitry (ASIC) and/or Digital Signal Processor (DSP) circuitry).

In addition, it will be appreciated that the various operations, processes, and methods disclosed herein may be embodied in a non-transitory machine-readable medium and/or a machine-accessible medium compatible with a data processing system (e.g., the earphone 200, the device 300, the server 400). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown in FIG. 6, or sequential order, to achieve desirable results. In addition, other steps may be provided, or steps may be eliminated, from the described flows, and other components may be added to, or removed from, the described systems. Accordingly, other embodiments are within the scope of the preceding disclosure.

Embodiments of the invention are discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems.

Features which are described in the context of separate embodiments may also be provided in combination in a single embodiment. Conversely, various features which are, for brevity, described in the context of a single embodiment, may also be provided separately or in any suitable sub-combination. The applicants hereby give notice that new claims may be formulated to such features and/or combinations of such features during the prosecution of the present application or of any further application derived therefrom.

References to “one embodiment,” “an embodiment,” “example embodiment,” “various embodiments,” “one or more embodiments,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least one or more embodiments of the invention” includes the stated particular feature, structure, or characteristic.

The enumerated listing of items does not imply that any or all of the items are mutually exclusive, unless expressly specified otherwise.

It is understood that the use of a specific component, device and/or parameter names are for example only and not meant to imply any limitations on the invention. The invention may thus be implemented with different nomenclature and/or terminology utilized to describe the mechanisms, units, structures, components, devices, parameters and/or elements herein, without limitation. Each term utilized herein is to be given its broadest interpretation given the context in which that term is utilized.

Devices or system modules that are in at least general communication with each other need not be in continuous communication with each other, unless expressly specified otherwise. In addition, devices or system modules that are in at least general communication with each other may communicate directly or indirectly throughout one or more intermediaries.

A description of an embodiment with several components in communication with each other does not imply that all such components are required. On the contrary a variety of optional components are described to illustrate the wide variety of possible embodiments of the present invention.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; a smartphone, application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, one or more embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The term “processor” may refer to any device or portion of a device that processes electronic data from registers and/or memory to transform that electronic data into other electronic data that may be stored in registers and/or memory. A “computing platform” may comprise one or more processors.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing the earphone, such as the earphone 100, according to the present invention will be apparent to those skilled in the art. Various aspects of the invention have been described above by way of illustration, and the specific embodiments disclosed are not intended to limit the invention to the particular forms disclosed. The particular implementation of the earphone may vary depending upon the particular context or application. The earphone 100 is just one example of an earphone having one or more of the present embodiments. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

We claim:

1. A method for reducing earbud utilization of computing memory resources and/or power resources, the method comprising:
initiating sound on a speaker of an earbud of a user, the sound produced from an audio comprising an audio track,
determining one or more physiological features of the user from physiological data received on one or more sensors of the earbud;
determining that a cognitive state of the user comprises a sleep state based on the one or more physiological features;
initiating a generative audio in response to a determination of the sleep state of the user,
fading the generative audio into the audio such that the audio further comprises the generative audio; and
fading the audio track out of the audio such that the generative audio replaces the audio track to reduce power consumption of the earbud associated with playing the audio track.

2. The method of claim 1, wherein the audio track is streamed to the earbud with a wireless connection, the method further comprising:
terminating the wireless connection upon fading the audio track out of the audio,
wherein the audio track is streamed from at least one of a mobile device communicatively coupled with the earbud, a base station of the earbud communicatively coupled with the earbud, and a computing device communicatively coupled to the earbud.

3. The method of claim 2, wherein the generative audio comprises a synthesized audio comprising one or more digital soundwave descriptors.

4. The method of claim 2, wherein the generative audio comprises a set of two or more sound samples that are composed such that the set of two or more sound samples are at least one of sequenced and overlayed.

5. The method of claim 3, further comprising:
inputting the one or more digital soundwave descriptors into a digital signal processor of a microprocessor of the earbud, referred to as a DSP;
generating an audio waveform on the DSP of the microprocessor; and
transmitting the audio waveform to a digital-to-analog converter of the earbud,
wherein the synthesized audio generated by an analog waveform of the audio waveform transformed by the digital-to-analog converter and transmitted to the speaker of the earbud.

6. The method of claim 5, further comprising:
parsing the audio track to determine a track feature of the audio track comprising an audio waveform of the track feature and an occurrence frequency the audio waveform of the track feature,
wherein the audio waveform of the track feature comprising one or more waves each comprising a soundwave frequency and soundwave amplitude; and
generating a generative feature comprising an audio waveform of the generative feature, the audio waveform of the generative feature comprising a set of one or more waves within a channel limit of the DSP, the audio waveform of the generative feature approximating the audio waveform of the track feature within the channel limit of the DSP;
generating within the generative audio the generative feature,
wherein the generative audio is generated at the occurrence frequency.

7. The method of claim 6, further comprising:
randomizing occurrence of the generative feature within the audio played on the speaker of the earbud,
wherein the one or more physiological features comprising at least one of a heart rate of the user, a heart rate variability of the user, a respiration rate of the user, a respiration rate variability of the user, and a temperature of the user,
wherein the physiological data describes one or more physiological indicators;
generating a soundwave descriptor library comprising the digital soundwave descriptor and one or more additional instances of the digital soundwave descriptor; and
transmitting the soundwave descriptor library to the earbud and storing the soundwave descriptor library in a computing memory of the earbud,
wherein the generative audio extracted from the soundwave descriptor library stored on the computing memory of the earbud.

8. A method for masking an environmental sound with an earbud utilizing reduced power and/or computing memory, the method comprising:
initiating sound on a speaker of an earbud of a user, the sound produced from an audioscape, comprising one or more audio features extracted from a generative library comprising two or more generative features arrangeable in real time to produce the audioscape;
collecting a first instance of the environmental sound from an environment of the user and storing the environmental sound as an environmental audio data;
wherein the first instance of the environmental sound collected on at least one of a microphone of the earbud and a microphone of a device communicatively coupled to the earbud;
isolating an environmental feature of the environmental sound from the environmental audio data,
wherein the environmental feature of the environmental sound comprising an audio waveform of the environmental sound comprising a plurality of waves;
decomposing the audio waveform of the environmental sound into two or more waves that are an approximation of the audio waveform of the environmental sound, each wave of the two or more waves comprised of a soundwave frequency and a soundwave amplitude,
wherein decomposition of the audio waveform comprising an application of a Fourier transform and identification of one or more dominant frequency bands;
determining whether at least one of the two or more generative features of the generative library meets a masking threshold for the audio waveform of the environmental sound;
determining a second instance of the environmental sound has been collected by the microphone of the earbud; and
generating a masking sound to mask the second instance of the environmental sound by playing a generative feature on the speaker of the earbud.

9. The method of claim 8, further comprising:
comparing one or more attributes of the audio waveform of the environmental sound with one or more attributes of an audio waveform of at least one of the two or more generative features within the generative library;
determining that the two or more generative features of the generative library are insufficient to mask the environmental sound; and
applying at least one of a frequency transformation and an amplitude transformation to the audio waveform of at least one of the two or more generative features to create a low-power masking sound within the audioscape of the generative library.

10. The method of claim 9, wherein the generative library comprises a soundwave descriptor library and the generative feature comprises one or more digital soundwave descriptors.

11. The method of claim 9, wherein the generative library comprises an audio sample library and the generative feature comprises an audio sample.

12. The method of claim 8, further comprising:
determining that the two or more generative features of the generative library are insufficient to mask the environmental sound; and
generating a new instance of the generative feature;
adding the new instance of the generative feature to the generative library as a masking feature; and
removing the new instance of the generative feature from the generative library upon termination of a sleep session of the user.

13. The method of claim 9, further comprising:
setting an ISO limit value in the computing memory establishing a feature rate limit for production of a sound associated with the generative feature within a time period;
upon determining the second instance of the environmental sound has been collected by the microphone of the earbud querying the ISO limit value; and
determining production of the sound associated with the generative feature is within the ISO limit value prior to playing the generative feature.

14. A method for managing an ISO state of a user utilizing an earbud, the method comprising:
receiving at a first time one or more physiological features of the user from one or more sensors of the earbud configured to collect physiological indicators;
determining that the ISO state of the user comprises a heightened iso state based on one or more physiological features determined based on the physiological indicators collected at the first time;
generating on a speaker of the earbud a sound from an audio, the audio comprising two or more generative features each comprising one or more digital soundwave descriptors extracted from a soundwave descriptor library stored on a computing memory of the earbud,
wherein the two or more generative features rendered at a first rate matching the ISO state of the user at the first time, and
wherein the two or more generative features rendered with a digital signal processor (DSP) of the earbud and a digital-to-analog converter (DAC) of the earbud;
reducing the first rate to a second rate of generative features rendered that is slower than the first rate;
receiving at a second time one or more physiological features of the user from the one or more sensors of the earbud;
determining that the ISO state of the user comprises a reduced ISO state based on the one or more physiological features received at the second time; and
maintaining the second rate of generative feature production, to adaptively manage the ISO state of the user utilizing reduced power and memory of the earbud.

15. The method of claim 14, further comprising:
reducing a number of generative features permitted to be rendered within the soundwave descriptor library upon a determination of the reduced ISO state.

16. The method of claim 15, further comprising:
reducing volume of at least one of the two or more generative features rendered from the soundwave descriptor library upon the determination of the reduced ISO state, and
lowering a tone of at least one of the two or more generative features rendered from the soundwave descriptor library upon the determination of the reduced ISO state.

17. The method of claim 16, further comprising:
fading the two or more generative features out of the audio; and
fading a broad spectrum mask into the audio such that the broad spectrum mask replaces the two or more generative features,
wherein the broad spectrum mask is at least one of a white noise, a pink noise, and a brown noise.

18. The method of claim 16, further comprising:
setting an ISO limit value in the computing memory establishing a feature rate limit for production of a generative sound within a time period;
upon determining an environmental sound has been collected by a microphone of the earbud querying the ISO limit value;
determining production of a masking sound is within the ISO limit value based on one or more rendered generative features; and
generating the masking sound.

19. The method of claim 18, further comprising:
querying an ISO baseline value of the user established through one or more pre-sleep sessions of the user.

20. The method of claim 19,
wherein the determination of the ISO state of the user based on comparison to the ISO baseline value of the user,
wherein the heightened iso state is an excited state of the user, and
wherein the reduced iso state is a calm state of the user.
